(19) United States
(12) Patent Application Publication
(10) Pub. No.: US 2008/0080747 A1
(43) Pub. Date: Apr. 3, 2008

(54) IMAGING APPARATUS AND IMAGING METHOD

(75) Inventor: Masaaki TAKAGI, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/865,227

(22) Filed: Oct. 1, 2007

(30) Foreign Application Priority Data
Sep. 29, 2006 (JP) 2006-267434

(51) Int. Cl. G06K 9/00

(52) U.S. Cl. 382/118

(57) ABSTRACT

A digital camera displays a camera-through image on an LCD panel, divided into control zones. The user can choose some of the control zones to extract face areas from the chosen control zones. Based on the size of an extracted face area, a shooting distance to a subject is estimated. If a difference between the estimated shooting distance and a shooting distance calculated based on a contrast value of the image is not over a threshold value, exposure conditions are decided on the basis of the estimated shooting distance. If the difference is over the threshold value, a blink sensing process is carried out. If any blinks are detected from the extracted face area, exposure conditions are decided on the basis of the estimated shooting distance. If no blink is detected, exposure conditions are decided on the basis of the calculated shooting distance.

### FIELD OF THE INVENTION

The present invention relates to an imaging apparatus for obtaining an electronic image, which can recognize faces of human subjects and decide exposure conditions so as to optimize the obtained image with respect to the faces. The present invention relates also to an imaging method for such an imaging apparatus.

### BACKGROUND OF THE INVENTION

As an imaging apparatus, digital cameras are widely used, which converts an optical image of a subject into an electronic image through a solid state imaging device like a CCD image sensor, and records the image in the form of digital image data in a built-in memory or a memory card. The digital cameras generally have an auto-focusing function, whereby its imaging lens is automatically focused on a center area of an imaging field when a shutter release button is pressed halfway. If a main subject does not exist in the center area of the imaging field then, the main subject can be out of focus.

To avoid such failure, conventional digital cameras require the users to frame the imaging field so as to locate the main subject in the center area and press the shutter release button halfway in this position to focus the imaging lens onto the main subject, and thereafter reframe the imaging field appropriately prior to pressing the shutter release button to the full. Thus, an image focused on the main subject is recorded even while the main subject is located in a peripheral position of the image.

However, this operation is certainly cumbersome. To overcome the above disadvantage, an imaging device has been suggested for example in JPA Nos. 2004-20628 and 2006-145629, which extracts face areas from an image by analyzing its image data, and adjusts the focus automatically on the basis of the extracted face areas.

The imaging device disclosed in JPA No. 2004-20628 automatically focuses onto the nearest subject when a plural number of face areas or subjects are detected from an image. But the nearest subject is not always the main subject expected by the user.

On the other hand, the imaging device disclosed in JPA No. 2006-145629 focuses on a face area or subject that is chosen by the user, so it comes to be possible to take an image according to the user's intention. However, since the whole area of the image is always subjected to the face extraction process in this prior art, it is a waste of time to extract other face areas than the chosen face area.

### SUMMARY OF THE INVENTION

In view of the foregoing, a primary object of the present invention is to provide an imaging apparatus and an imaging method, which save time for imaging processes and permit taking an image according to the user's intention.

According to the present invention, an imaging apparatus comprises an imaging device for obtaining an electronic image from an optical image of a subject formed through an imaging lens; a display device for displaying the obtained image on a screen divided into control zones; a choosing device operated to choose some of the control zones; and a processing device for processing data of the obtained image, wherein the processing device processes the data in each of the chosen control zones individually, but treats adjoining two or more of the chosen control zones as a united control zone.

Since the data processing is carried out on the chosen control zones, the time for processing the data is reduced in comparison with a case where the data processing is carried out on the whole image area. Treating the adjoining chosen control zones as a united control zone, the requisite number of times of processing is minimized.

Preferably, the processing device carries out a face extraction process for extracting face areas from the image. If no face area is extracted from the chosen control zones, the face extraction process is carried out on other control zones than the chosen control zones. This configuration ensures extraction of existing face areas from the image even if the user would fail to choose adequate control zones.

According to a preferred embodiment, the imaging apparatus of the present invention further comprises an operating device operated to record the image as obtained through the imaging device; an exposure condition controlling device for deciding a set of exposure conditions of the imaging device on the basis of a face area extracted through the face extraction process; and a successive shot control device that controls the exposure condition controlling device to decide different sets of exposure conditions on the basis of respective face areas if more than one face area is extracted, wherein the successive shot control device controls the imaging device to make successive shots to take and record a number of images under the different sets of exposure conditions upon one operation on the operating device.

Thereby, it comes to be possible to obtain a series of images upon one operation on the operating device, like a shutter release button, under the different sets of exposure conditions optimized for the respective face areas, while focusing on different subjects that correspond to the extracted face areas.

More preferably, the imaging apparatus of the present invention further comprises a device for detecting shooting distances to respective subjects corresponding to the extracted face areas; a calculation device for calculating differences between the shooting distances to the subjects; and a judging device for judging whether the calculated differences are within a particular range, wherein the exposure condition control device sorts such face areas into a group that correspond to those subjects, between which the difference in shooting distance is within the particular range, and decides a set of exposure conditions for each group.

The particular range is preferably a depth of field of the imaging lens. If the extracted face areas are sorted into two or more groups, the exposure condition control device preferably elongates the depth of field by narrowing a stop aperture of the imaging lens and sorts the face areas again with reference to the elongated depth of field, to decide a set of exposure conditions for each group as sorted with reference to the elongated depth of field.

Thus, the number of successive shots upon one operation on the operating device is reduced to the requisite minimum.

According to a preferred embodiment, the successive shots are executed under the respective sets of exposure conditions in the same order as these sets of exposure conditions are decided.

According to another preferred embodiment, the successive shots are executed while focusing the imaging lens at a different group of the subjects from one shot to another, in the order from a group of the shortest shooting distance or from a group of the longest shooting distance. Thereby, a series of images focused at the different groups of the human subjects are obtained successively upon one operation on the shutter release button, while driving the imaging lens in one direction only.

The face extraction process may be carried out by sliding face patterns of a constant size on the image. In that case, the imaging apparatus further comprises an image size control device for changing the size of the image so as to adjust the sizes of face areas to the size of the face patterns. Preferably, the image size control device reduces the size of the image when the shooting distance is shorter than a predetermined distance, and enlarges the size of the image when the shooting distance is longer than the predetermined distance. The image size control device may also reduce the size of the image when the zoom lens is on a telephoto side, and enlarge the size of the image when the zoom lens is on a wide-angle side. The image size control device reduces the size of the image when no face area is extracted from the image in an initial size, and the processing device slides the face patterns on the reduced image to retry to extract face areas.

The face extraction process may also be carried out by use of face patterns of a variable size. Then, the processing device enlarges the size of the face patterns when the shooting distance is shorter than a predetermined distance, and reduces the size of the face patterns when the shooting distance is longer than the predetermined distance. The processing device also enlarges the size of the face patterns when the zoom lens is on a telephoto side, and reduces the size of the face patterns when the zoom lens is on a wide-angle side. The processing device enlarges the size of the face patterns when no face area is extracted, and retries to extract face areas using the enlarged face patterns.

This embodiment ensures extracting all face areas from the chosen zones even while the face areas have different sizes in the image. Since the face area size in the image changes according to the distances of the corresponding subjects to the imaging apparatus as well as the zooming position of the imaging lens, changing the image size or the face pattern size depending upon the shooting distance or the zooming position improves the efficiency of the face extraction process.

According to still another embodiment, the imaging apparatus of the present invention further comprises a shooting distance estimation device for estimating a shooting distance to a subject on the basis of the size of a face area of the subject extracted through the face extraction process; a shooting distance measuring device for measuring a shooting distance to the subject; a calculation device for calculating a difference between the estimated shooting distance and the measured shooting distance; a second judging device for judging whether the calculated difference is over a predetermined threshold value; and an exposure condition controlling device for deciding exposure conditions of the imaging device, wherein the exposure condition control device decides the exposure conditions on the basis of the estimated shooting distance when the calculated difference is not over the threshold value.

When the calculated difference is over the threshold value, a blink sensing device is activated to detect blinks from the face area. If the blink sensing device detects some blinks, the exposure conditions are decided on the basis of the estimated shooting distance. If the blink detecting device does not detect any blinks, the exposure condition control device decides the exposure conditions on the basis of the measured shooting distance.

Thereby, it is checked whether the extracted face area is a person's or not. If it is determined that the face area is not a person's, the shooting distance estimated by the face area size is canceled, and the measured shooting distance is adopted.

This embodiment prevents the imaging lens from being focused on a nonhuman subject that has an area recognized as a face, and thus prevents the image from getting out of focus.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a front perspective view of a digital camera according to a first embodiment of the invention;

FIG. 2 is a rear view of the digital camera of FIG. 1;

FIG. 3 is a block diagram illustrating an electric structure of the digital camera of FIG. 1;

FIG. 4 is an explanatory diagram illustrating a face pattern served for a face extraction process;

FIGS. 5A and 5B are explanatory diagrams illustrating a step of the face extraction process, wherein the image size is changed to detect face areas of various sizes;

FIGS. 6A and 6B are explanatory diagrams illustrating an image size changing step of the face extraction process, in a case where the subject exists in a near range;

FIGS. 7A and 7B are explanatory diagrams illustrating the image size changing step in a case where the subject exists in a far range;

FIGS. 8A and 8B are explanatory diagrams illustrating the image size changing step of the face extraction process in a case where a zoom lens is on a telephoto side;

FIGS. 9A and 9B are an explanatory diagrams illustrating the image size changing step in a case where the zoom lens is on a wide-angle side;

FIG. 10 is an explanatory diagram illustrating a screen of an LCD panel, divided into control zones;

FIGS. 11A and 11B are explanatory diagrams illustrating an example of a camera-through image divided into the control zones on the LCD panel;

FIG. 12 is an explanatory diagram illustrating an example of a display condition on the LCD panel, displaying an error warning that no face is detected from chosen control zones;

FIGS. 13A and 13B are explanatory diagrams illustrating a step of the face extraction process, wherein the control zones searched for the face area are extended from the initial chosen ones;

FIGS. 14A and 14B are graphs illustrating a relationship between shooting distance and face area size in an image and a relationship between shooting distance and contrast value of the image;

FIGS. 15A, 15B and 15C are explanatory diagrams illustrating an example of a shooting distance to a human subject estimated based on a face area size of the subject and a shooting distance calculated based on an image contrast value;

FIGS. 16A, 16B and 16C are explanatory diagrams illustrating another example of a shooting distance to a human subject estimated based on a face area size of the subject and a shooting distance calculated based on an image contrast value;

FIGS. 17A, 17B and 17C are explanatory diagrams illustrating an example of a shooting distance to a nonhuman subject estimated based on a face area size of the subject and a shooting distance calculated based on an image contrast value;

FIG. 18 is an explanatory diagram illustrating an example of a display condition on the LCD panel, displaying an error warning that the subject is not a person;

FIG. 19 is an explanatory diagram illustrating an example of a display condition on the LCD panel, displaying an error warning that no face area is detected from the whole image;

FIGS. 20A and 20B are explanatory diagrams illustrating an example of a face area grouping process in a successive portrait mode, whereby face areas of subjects are grouped with respect to shooting distances to the respective subjects, considering the depth of field;

FIG. 21 is an explanatory diagram illustrating an example of a display condition on the LCD panel, displaying the number of successive shots upon a shutter release operation;

FIG. 22 is a flowchart illustrating an overall sequence of operations in the successive portrait mode;

FIG. 23 is a flowchart illustrating the image size changing step of the face extraction process, for changing the image size depending upon the shooting distance;

FIG. 24 is a flowchart illustrating the image size changing step of the face extraction process, for changing the image size depending upon the zooming position;

FIG. 25 is a flowchart illustrating a step of retrying to extract a face area in the face extraction process;

FIG. 26 is a flowchart illustrating a step of deciding a shooting distance;

FIG. 27 is a flowchart illustrating a step of grouping face areas, to decide exposure conditions for each group;

FIG. 28 is a front perspective view of a lens-interchangeable digital camera according to a second embodiment of the invention;

FIG. 29 is a block diagram illustrating an electric structure of the digital camera of FIG. 28;

FIGS. 30A and 30B are explanatory diagrams illustrating a step of the face extraction process, wherein the size of the face pattern is changed to detect face areas of various sizes;

FIGS. 31A and 31B are explanatory diagrams illustrating a face pattern size changing step of the face extraction process, in a case where the subject exists in a near range;

FIGS. 32A and 32B are explanatory diagrams illustrating the face pattern size changing step, in a case where the subject exists in a far range;

FIGS. 33A and 33B are explanatory diagrams illustrating the face pattern size changing step of the face extraction process, in a case where the zoom lens is on a telephoto side;

FIGS. 34A and 34B are an explanatory diagrams illustrating the face pattern size changing step in a case where the zoom lens is on a wide-angle side;

FIG. 35 is a flowchart illustrating the image size changing step of the face extraction process, for changing the face pattern size depending upon the shooting distance;

FIG. 36 is a flowchart illustrating the image size changing step of the face extraction process, for changing the face pattern size depending upon the zooming position; and

FIGS. 37A and 37B are explanatory diagrams illustrating a step of choosing control zones on the LCD panel.

### DESCRIPTION OF THE PREFERRED EMBODIMENTS

### First Embodiment

Now a digital camera 11 according to a first embodiment of the present invention will be described with reference to the drawings, but the present invention will not be limited to the following embodiment.

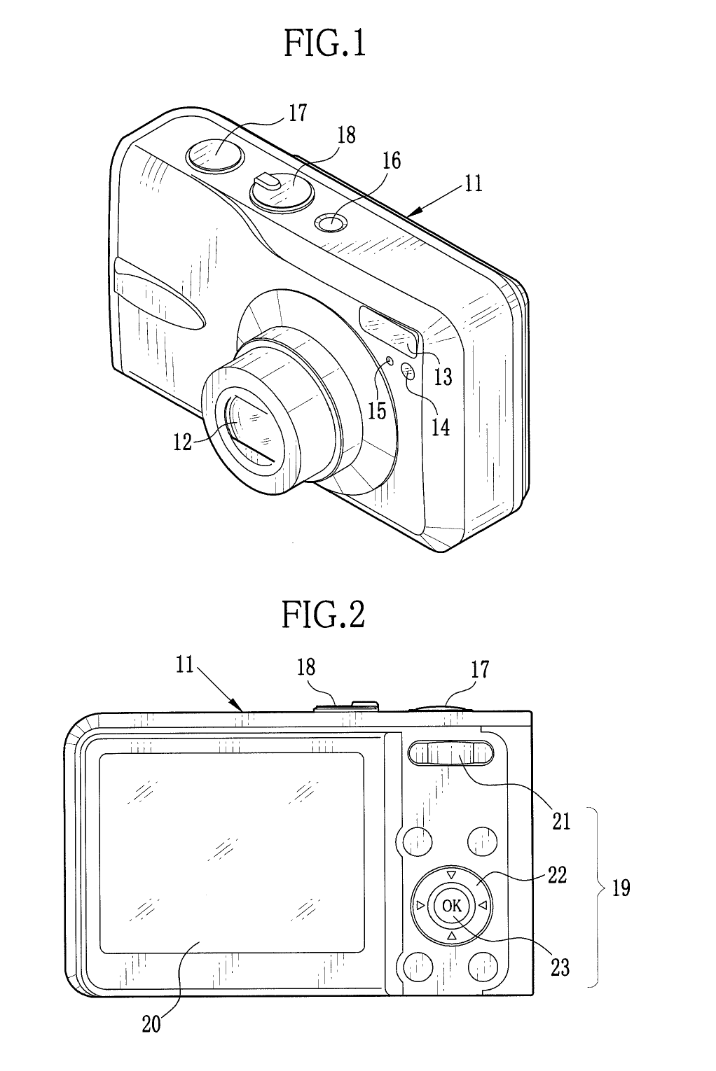

As shown in FIG. 1, the digital camera 11 has an imaging lens 12, a flash projector 13, a supplemental light projector 14 and an infrared sensor 15 on its front. The imaging lens 12 lets light enter the digital camera 11 and forms an optical image from the light. The flash projector 13 flashes synchronously with a recording shot for recording an image, so as to adjust an exposure amount. The supplemental light projector 14 emits a light signal to the subject. The infrared sensor 15 projects infrared beams toward the subject and receives reflected infrared waves from the subject, to output an electric signal that varies depending upon the intensity of the reflected waves, as set forth in detail later.

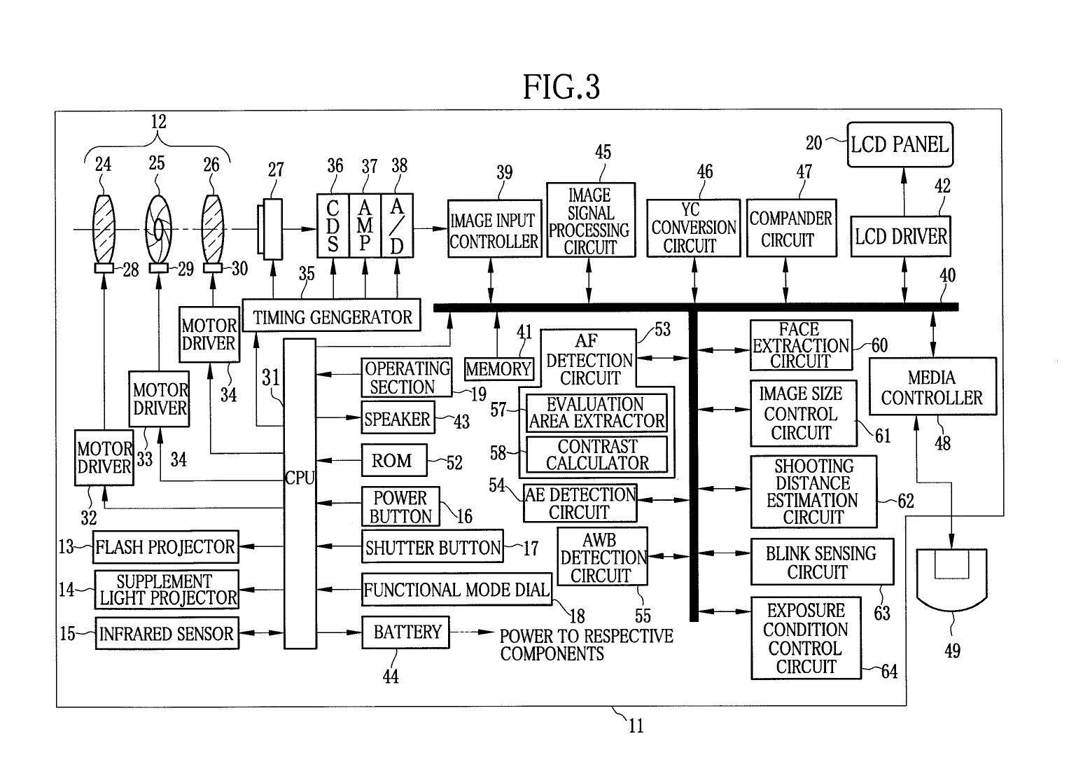

The digital camera 11 also has a power button 16, a shutter release button 17 and a functional mode dial 18 on its top side. The power button 16 powers the digital camera 11 on or off each time the power button 16 is pressed. When the digital camera 11 is powered on, a battery 44 supplies power to respective components of the digital camera 11 (see FIG. 3). The shutter release button 17 is pressed to make the recording shot. The functional mode dial 18 is turned to switch over the digital camera 11 between a camera mode, a video mode, a reproduction mode, a menu mode and a successive portrait mode. The camera mode is a mode for recording still images, the reproduction mode is a mode for reproducing the recorded still images, the video mode is a mode for recording moving images, and the menu mode is a mode for changing setup values for image-processing, such as white-balance, ISO speed and color-balance. The successive portrait mode is a mode wherein two or more still images of the same subject are successively obtained and recorded each time the shutter release button 17 is pressed to the full.

As shown in FIG. 2, the digital camera 11 has a liquid crystal display (LCD) panel 20 and an operating section 19 on its back side, the operating section 19 consists of a zoom button 21, an arrow key button 22 and an enter button 23. The LCD panel 20 displays setup menu screens in the menu mode, and camera-through images during a standby stage in the camera mode and the successive portrait mode. So the user may press the shutter release button 17 to make the recording shot for recording at least an image while looking at the camera-through images on the LCD panel 20. Besides, a speaker 43 (see FIG. 3) is provided on a bottom side of the digital camera 11.

As shown in FIG. 3, the imaging lens 12 consists of a zoom lens 24, a stop 25 and a focus lens 26. A CCD image sensor 27 is placed behind the imaging lens 12. The zoom lens 24 is driven by a zoom lens motor 28 to change the magnification of the imaging lens 12. The stop 25 is driven by an iris motor 29 to change the aperture size. The focus lens 26 is driven by a focus lens motor 30 to adjust the focal point of 12. The motors 28, 29 and 30 are driven respectively by motor drivers 32, 33 and 34, which are connected to a CPU 31 and controlled by the CPU 31.

The CCD image sensor 27 picks up an image signal from an optical image formed through the imaging lens 12. The CCD image sensor 27 is connected to a timing generator (TG) 35, which is controlled by the CPU 31, so that the timing generator 35 applies a timing signal or a clock pulse to the CCD image sensor 27, to decide the electronic shutter speed of the CCD image sensor 27.

The imaging signal obtained through the CCD image sensor 27 is fed to a correlated double sampling (CDS) circuit 36, and then to an amplifier (AMP) 37. The CDS circuit 36 outputs three color image signals (R, G, B) that exactly reflect amounts of electrostatic charges accumulated in respective cells of the CCD image sensor 27. The amplifier 37 amplifies the image signals. The amplified image signals are converted into RGB digital image data through an A/D converter 38.

An image input controller 39 is connected through a data bus 40 to the CPU 31, so as to control the CCD image sensor 27, the CDS circuit 36, the amplifier 37 and the A/D converter 38 according to the commands from the CPU 31. The image input controller 39 outputs the image data from the A/D converter 38 to the data bus 40 at predetermined intervals, to store the image data in a memory 41. The memory 41 is provided with an image memory location for storing the image data. The image data is then read out from the memory 41, and sent to an LCD driver 42 to display the camera-through image on the LCD panel 20. Note that the memory 41 is also provided with a work memory location.

An image signal processing circuit 45 processes the image data for gradation conversion, white-balance correction, gamma correction and the like. The image data processed in the image signal processing circuit 45 is converted through an YC conversion circuit 46 to a luminance signal Y and chrominance signals Cr and Cb. A compander circuit 47 compresses the image data according to a predetermined format, e.g. JPEG format. The compressed image data is recorded on a memory card 49 by a media controller 48. In the reproduction mode, the image data is read out from the memory card 49, and decompressed in the compander circuit 47, and then served for displaying the recorded images on the LCD panel 20.

The CPU 31 is also connected to a ROM 52, which stores a variety of control programs and setup information. The CPU 31 reads the program and the information from the Rom 52, to execute necessary processing.

The data bus 40 is connected to an AF detection circuit 53, an AE detection circuit 54 and an AWB detection circuit 55. The AF detection circuit 53 detects whether the focal position of the focus lens 26 is proper or not. The AE detection circuit 54 detects whether exposure conditions, such as the electronic shutter speed of the CCD image sensor 27, the imaging sensitivity, and the aperture value of the stop 25, are proper or not. The AWB detection circuit 55 detects whether the white-balance correction is proper or not. These detection circuits 53 to 55 send their detection results through the data bus 40 to the CPU 31. The CPU 31 controls the zoom lens 24, the stop 25, the focus lens 26 and the CCD image sensor 27 individually on the basis of the detection results of the detection circuit 53 to 55.

The AF detection circuit 53 is provided with an evaluation area extractor 57 and a contrast calculator 58, and controls the focus of the imaging lens 12 according to a contrast detection method. Specifically, the evaluation area extractor 57 extracts image components from one or more than one predetermined focus evaluation area. The contrast calculator 58 detects a contrast value of the image on the basis of the extracted image components. The AF detection circuit 53 calculates a shooting distance to a subject on the basis of the contrast value obtained by the contrast calculator 58, and judges the focusing condition of the image, to decide a proper focal position of the focus lens 26. Note that the focusing in the contrast detection method is carried out each time the shutter release button 17 is pressed halfway in the camera mode.

The AE and AWB detection circuits 54 and 55 calculate a proper exposure value and a proper white-balance correction amount on the basis of luminance information of the image data that is written in the memory 41 at predetermined intervals. The exposure value and the white-balance correction amount are sent from the AE and AWB detection circuits 54 and 55 to the CPU 31, so the CPU 31 continually controls the electronic shutter, the stop 25 and the image processing on the basis of the information from these circuits 54 and 55.

To the data bus 40 are also connected a face extraction circuit 60, an image size control circuit 61, a shooting distance estimation circuit 62, a blink sensing circuit 63 and an exposure condition control circuit 64. The face extraction circuit 60 carries out a face extraction process for extracting face areas from the camera-through image displayed on the LCD 19. The image size control circuit 61 changes the image size on the face extraction process. The shooting distance estimation circuit 62 estimates a shooting distance to a subject. The blink sensing circuit 63 detects blinks from the image. The exposure condition control circuit 64 decides exposure conditions on the basis of the shooting distance. These circuits 60 to 64 seriatim send the respective processing results through the data bus 40 to the CPU 31, so the CPU 31 makes necessary controls on the basis of these results from the circuits 60 to 64.

[Face Extraction Process]

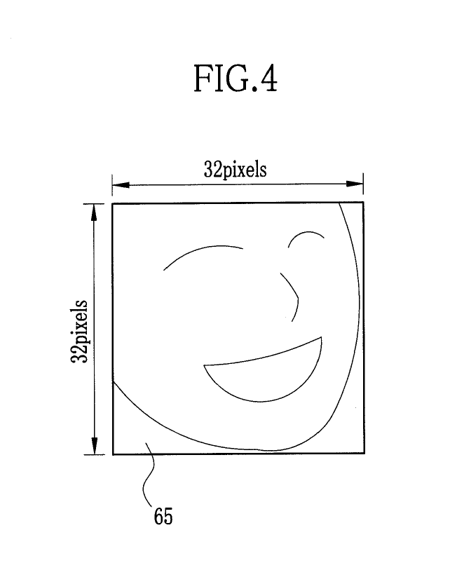

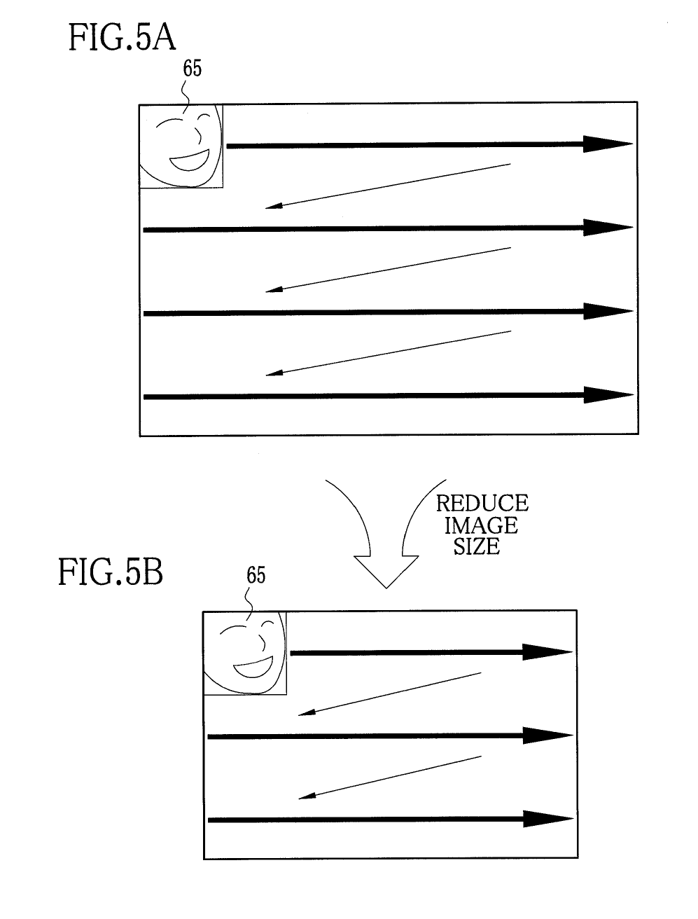

The face extraction circuit 60 extracts face areas by a pattern recognition method that adopts for example an algorithm called Boosting. The ROM 52 stores several kinds of face patterns 65, each of which has a square area of 32×32 pixels, as shown for example in FIG. 4. In the face extraction process, the face patterns 65 are slid or slid on the image, as shown in FIG. 5A, to recognize such areas as the face areas that have the same pattern as the face patterns 65. As the face patterns 65 are fixed in size, but the face areas contained in the image are generally different in size fromeachother, the sliding of the facepatterns 65 is repeated after reducing the size of the image, as shown in FIG. 5B, to extract the face areas of different sizes. The image size control circuit 61 serves for changing the image size.

[Subject/Near]

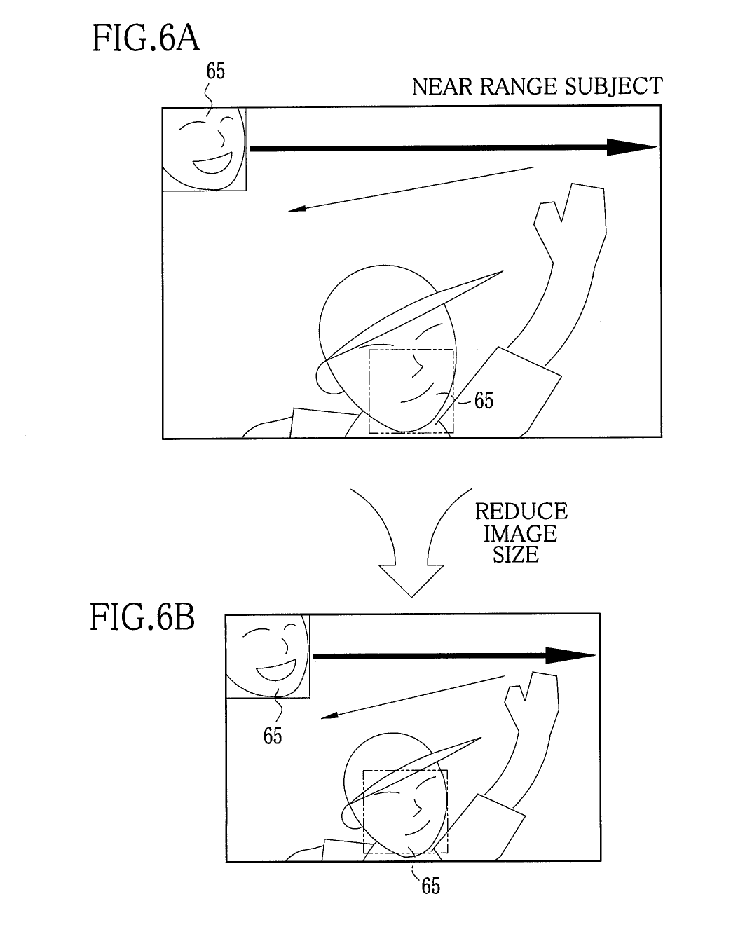

The size of a face area in the image varies depending upon the shooting distance to the subject. If the subject exists in a near range that is shorter than a predetermined distance, the face area in the initial image size is larger than the square face patterns 65 of 32×32 pixels, as shown for example in FIG. 6A, so it is hard to detect the face area without reducing the image size. Therefore, if the shooting distance calculated by the AF detection circuit 53 is shorter than the predetermined distance, the image size is first reduced by the image size control circuit 61, as shown in FIG. 6B, and then the face patterns 65 are slid on the reduced image, to extract the face area.

[Subject/Far]

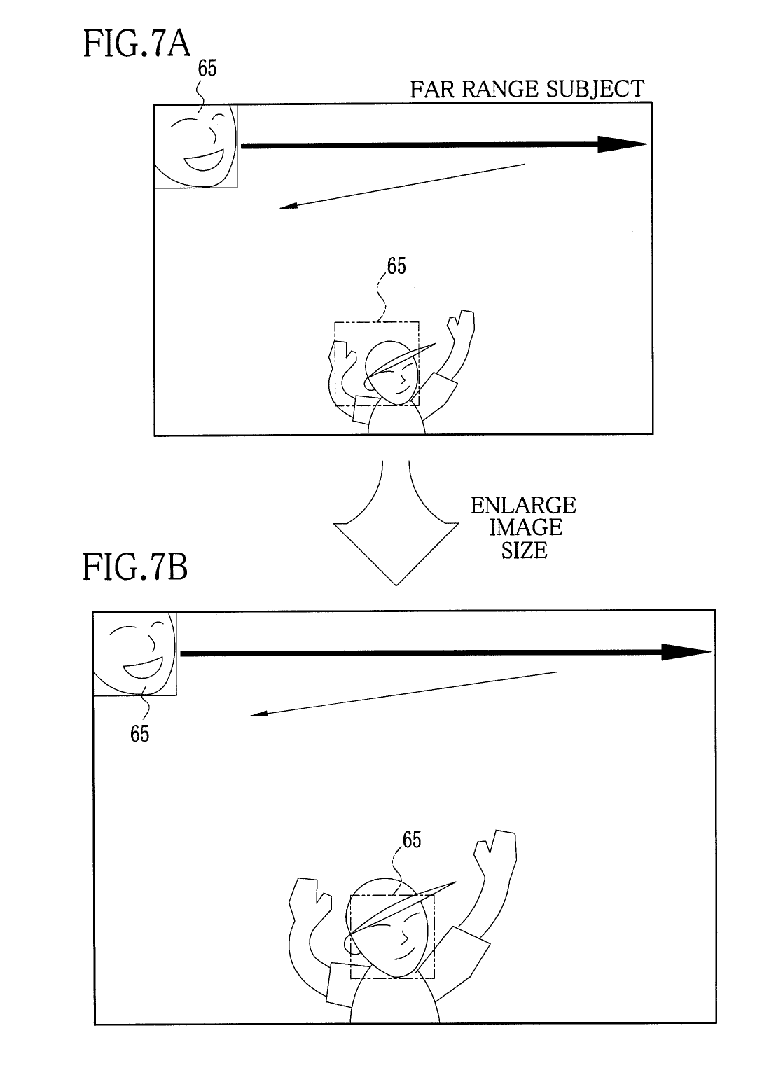

If the subject exists in a far range that is beyond the predetermined distance, the face area in the initial image size is smaller than the square face patterns 65 of 32×32 pixels, as shown for example in FIG. 7A, so it is hard to detect the face area in the initial image size. Therefore, if the shooting distance calculated by the AF detection circuit 53 is longer than the predetermined distance, the image size is first enlarged by the image size control circuit 61, as shown in FIG. 7B, and then the face patterns 65 are slid on the enlarged image to extract the face area.

[Zoom/Tele]

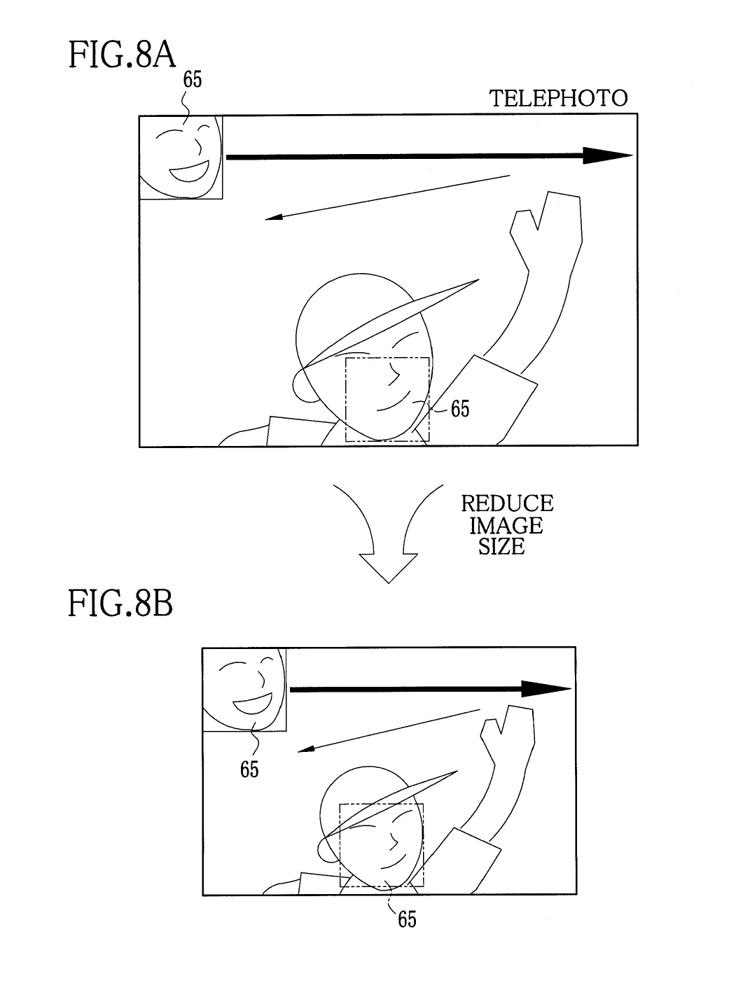

The size of a face area in the image also varies depending upon the focal length. That is, if the zoom lens 24 is on a telephoto side from a predetermined position, the face area is larger than the square face patterns 65 of 32×32 pixels, as shown for example in FIG. 8A, so it is hard to detect the face area in the initial image size. Therefore, if the CPU 31 judges that the zoom lens 24 is on the telephoto side, the image size is first reduced by the image size control circuit 61, as shown in FIG. 8B, and then the face patterns 65 are slid on the image to extract the face area.

[Zoom/Wide]

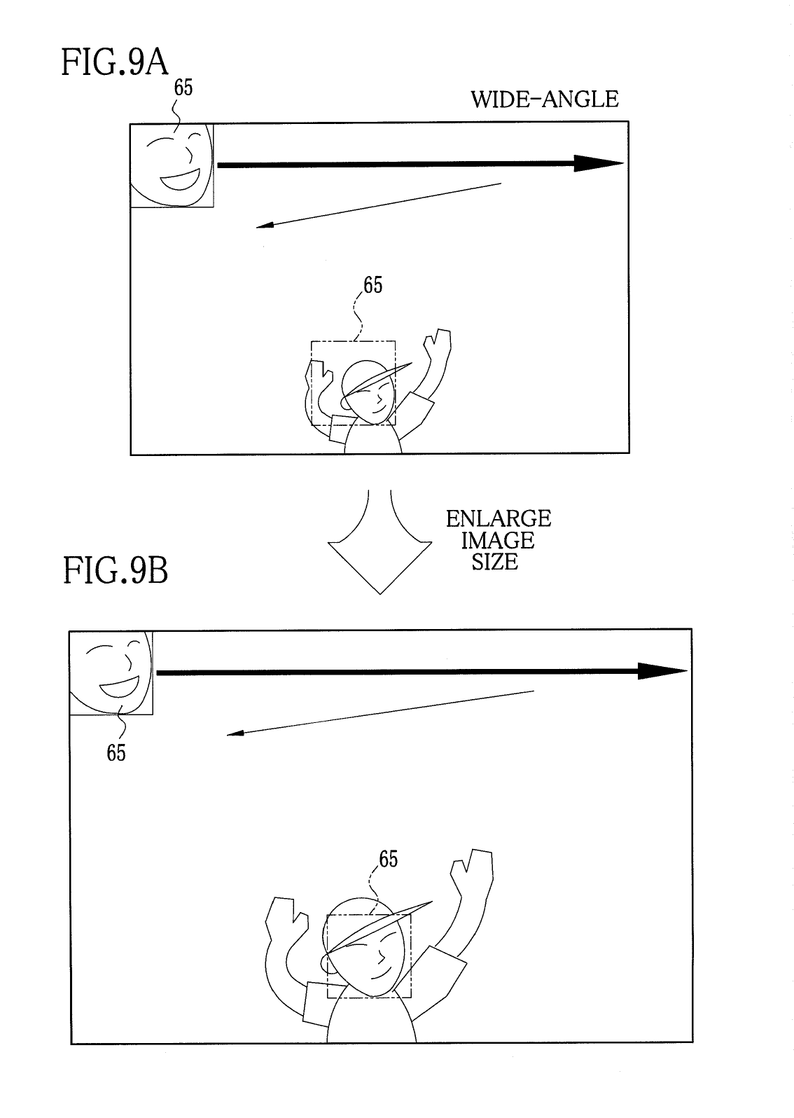

If the zoom lens 24 is on a wide-angle side from the predetermined position, the face area in the initial image size is smaller than the square face patterns 65 of 32×32 pixels, as shown for example in FIG. 9A, so it is hard to detect the face area in the initial image size. Therefore, if the CPU 31 judges that the zoom lens 24 is on the wide-angle side, the image size is first enlarged by the image size control circuit 61, as shown in FIG. 9B, and then the face patterns 65 are slid on the image, to extract the face area.

[Control Zones]

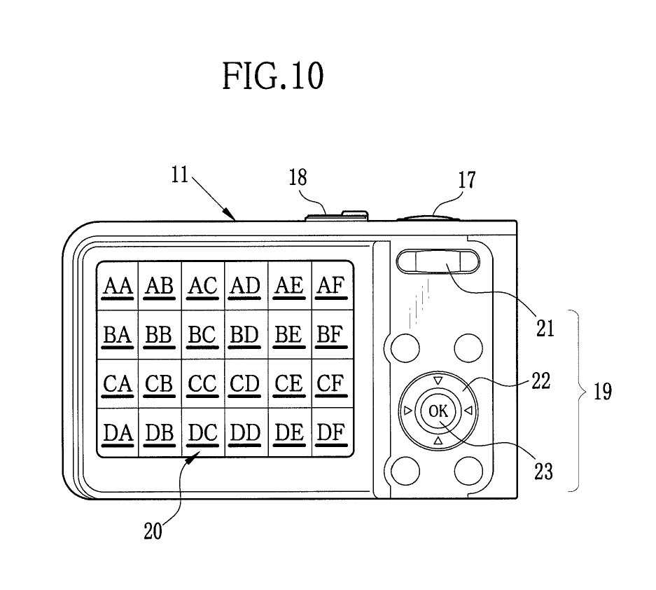

In the standby stage of the successive portrait mode, the LCD panel 20 displays the camera-through images. As shown for example in FIG. 10, the LCD panel 20 is divided into control zones AA to DF arranged in a 4×6 matrix, i.e. four lines A to D and six columns A to F, under the control of the CPU 31.

[Choice of Control Zones]

When the user touches the LCD panel 20 at one or more of the control zones AA to DF, the touched zones are chosen provisionally. That is, the LCD panel 20 doubles as a touch panel. The provisionally chosen control zones are discriminated from others, as their backgrounds get darker or deeper colors. When the shutter release button 17 is pressed in this condition, the choice of the control zones AA to DF is fixed. Then, the image data of the chosen control zones are subjected to the face extraction process and other predetermined processes.

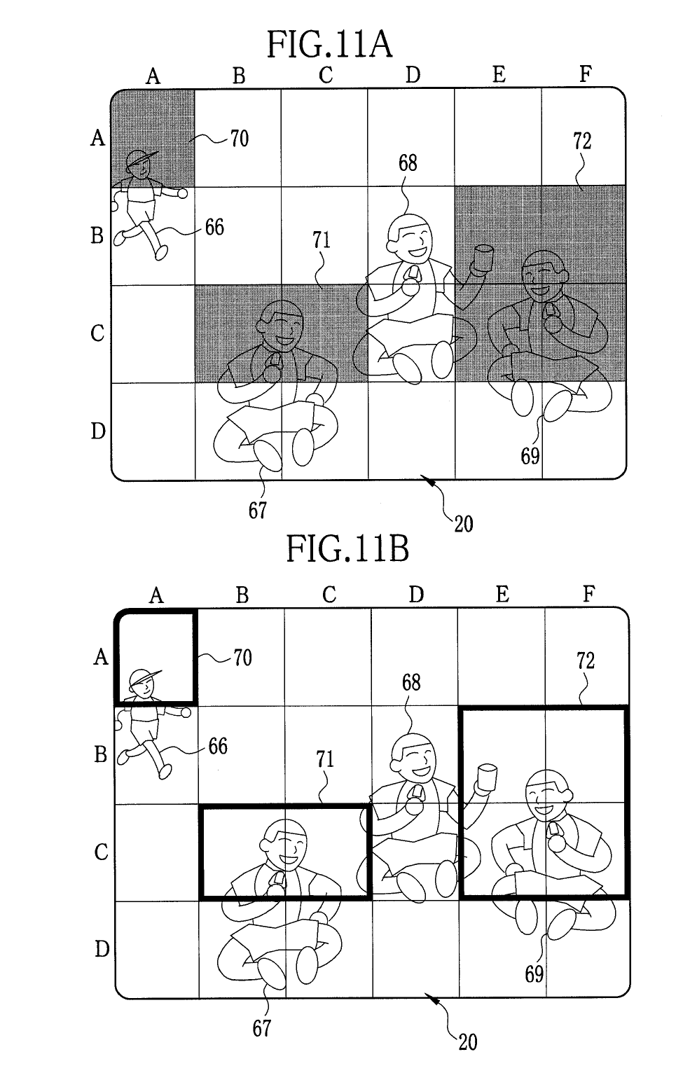

As shown for example in FIG. 11A, when the user provisionally chooses the control zones AA, BE, BF, CB, CC, CE and CF, the background color of these control zones AA, BE, BF, CB, CC, CE and CF gets darker. Thereafter when the choice of these control zones AA, BE, BF, CB, CC, CE and CF is fixed, the face extraction process starts to extract face areas contained in the chosen control zones AA, BE, BF, CB, CC, CE and CF. In the illustrated example, face areas of three persons 66, 67 and 69 are detected, while a face area of a person 68 is not detected because it is not contained in the chosen control zones AA, BE, BF, CB, CC, CE and CF.

[Adjoining Control Zones]

When adjoining two or more control zones are chosen, the CPU 31 processes the adjoining control zones as a unit. In the example shown in FIG. 11, the chosen control zones CB and CC are regarded as a unit, and the chosen control zones BE, BF, CE and CF are regarded as another unit. Also the single control zone AA is regarded as another chosen unit. Hereinafter, the chosen control zone AA is referred to as the first control zone 70, the unit consisting of the chosen control zones CB and CC is referred to as the second control zone 71, and the unit consisting of the chosen control zones BE, BF, CE and CF is referred to as the third control zone 72.

[Order of Processing]

The control zones 70 to 72 are subjected to the face extraction process and other processes in turn, in the order from the first chosen one to the last chosen one. For example, if the control zones AA, CE, CF, CB, CC, BE and BF are chosen in this order, the control zone CB is chosen first among those constituting the second control zone 71, and the control zone CE is chosen first among those constituting the third control zone 72. Because the control zone AA is chosen first of all, and the control zone CE is chosen before the control zone CB, the first control zone 70 including the first chosen control zone AA is processed first, and the third control zone 72 including the control zone CE is processed next. Thereafter, the second control zone including the control zone CB is processed. As a result, the face area of the person 66, called Mr. X, is detected first, the face area of the person 69, called Mr. Z, is detected next, and the face area of the person 67, Mr. Y, is detected last.

[Error Warning]

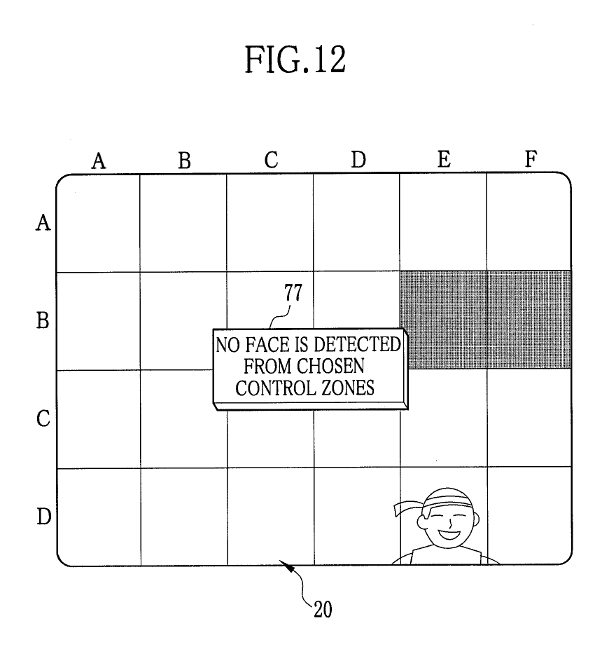

If no face area is detected from the chosen control zones, an error warning is given, informing the user to the fact that no face area is detected from the chosen control zone. For example, as shown in FIG. 12, if the user chooses merely those control zones BE and BF which do not contain any human subject, no face area is detected by the face extraction process. Then, the CPU 31 causes the LCD panel 20 to display an error warning 77.

[Error Warning/Self-timer Shooting]

On a self-timer shooting, however, where the shooting starts in a preset time after the user presses the shutter release button 17 to the full and then comes in the shooting field as a subject, the user cannot notice the error warning 77 if it is displayed on the LCD panel 20 located on the back side of the digital camera 11. In order to warn the user of the error that no face area is detected from chosen control zones on the self-timer shooting, the supplemental light projector 14 emits light to give the warning that no face area is detected from the chosen control zones.

[Re-Extraction]

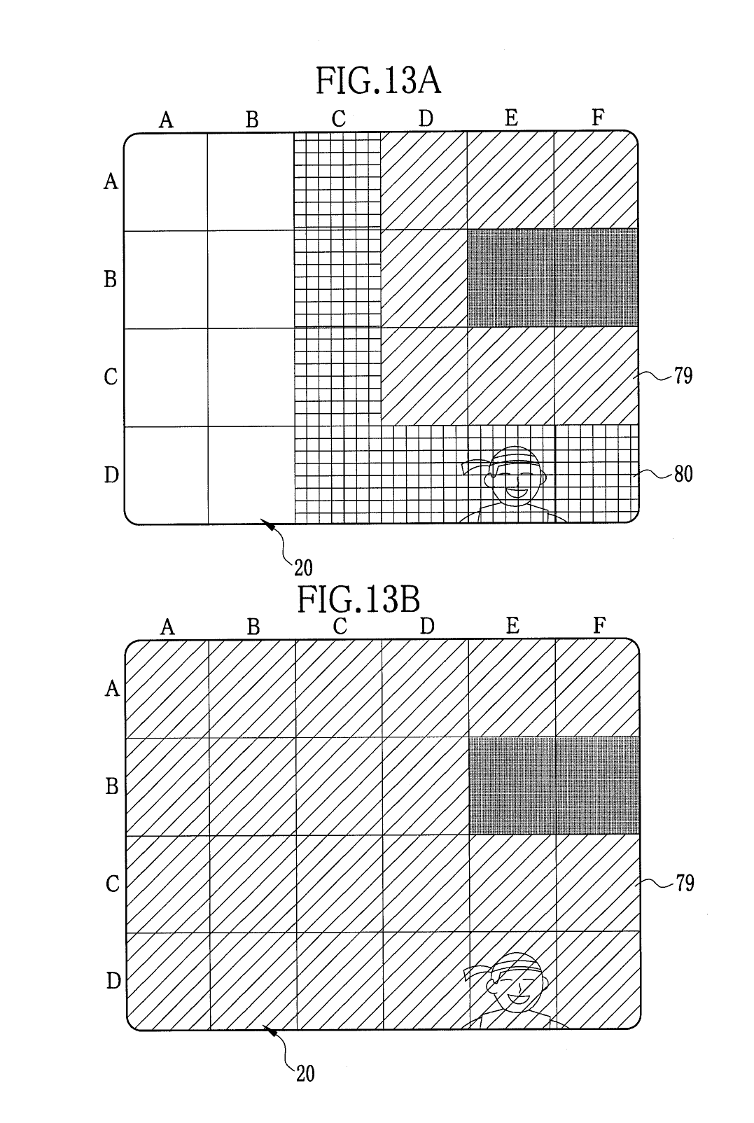

When no face area is extracted from the chosen control zones, the face extraction circuit 60 retries to extract a face area those control zones which adjoin the chosen control zones. For example, as shown in FIG. 13A, if the user chooses the control zones BE and BF but no face area is detected from the chosen control zones BE and BF, the control zones AD, AE, AF, BD, CD, CE and CF, which adjoin the chosen control zones BE and BF, are subjected as a first peripheral zone 79 to the face extraction process. If no face area is detected from the first peripheral zone 79, the control zones AC, BC, CC, DC, DD, DE and DF are subjected as a second peripheral zone 80 to the face extraction process. In the example shown in FIG. 13A, a face area is detected from the control zone DE that is included in the second peripheral zone 80. But in a case where no face area is detected in the second peripheral zone 80, the face extraction circuit 60 repeats the same process on other peripheral zones until a face area is detected.

[Shooting Distance Estimation]

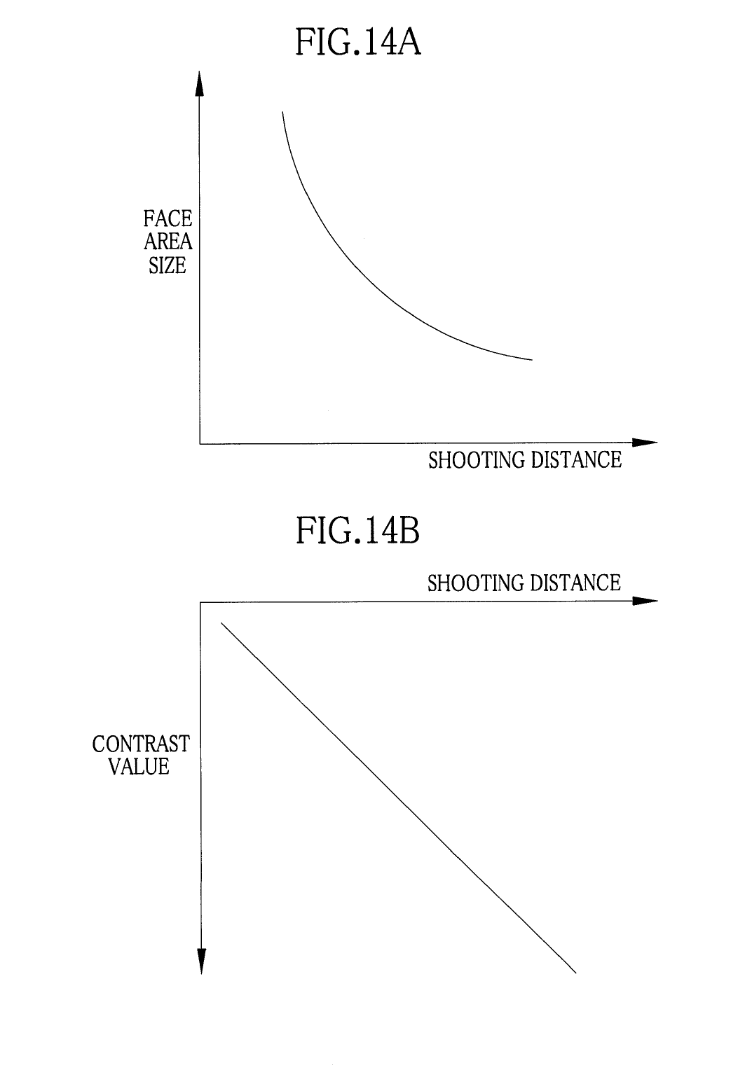

Based on the size of the extracted face area and numerical data stored previously in the ROM 52, the shooting distance estimation circuit 62 estimates a shooting distance to the subject. Substantially, the face area size is inversely proportional to the shooting distance, as shown in FIG. 14A, wherein a horizontal axis represents the shooting distance, and a vertical axis represents the size of extracted face area. The shooting distance estimation circuit 62 further compares the estimated shooting distance with a shooting distance, which is calculated by the contrast calculator 58 of the AF detection circuit 53, and calculates a difference between the estimated and calculated shooting distances. The shooting distance estimation circuit 62 checks whether the calculated difference is over a predetermined threshold value that is previously stored in the ROM 52. Note that the contrast value obtained by the contrast calculator 58 is approximately proportional to the shooting distance calculated by the AF detection circuit 53, as shown in FIG. 14B, wherein a horizontal axis represents the shooting distance, and a vertical axis represents the contrast value. When the shooting distance estimation circuit 62 judges that the difference is not over the threshold value, an exposure condition deciding process is carried out on the basis of the shooting distance estimated by the face area size, as will be described in detail later. On the other hand, if the difference is over the threshold value, the blink sensing circuit 63 carries out a blink sensing process.

[Blink Sensing Process]

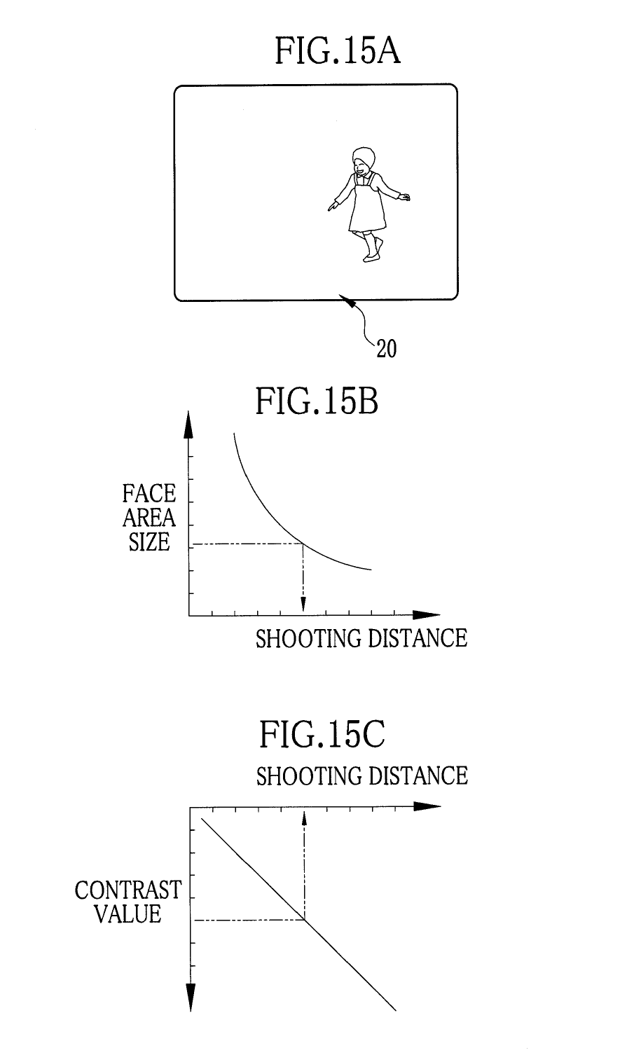

When the shooting distance estimation circuit 62 judges that the difference between the estimated and calculated shooting distances is over the threshold value, the blink sensing circuit 63 carries out the blink sensing process for detecting blinks from the extracted face area. For example, the blink sensing circuit 63 judges based on a detection signal from the infrared sensor 15 whether the face area shows any blinks, because the intensity of the infrared wave reflected from eyes differs from when it is reflected from eyelids. If anyblinks are detected, the exposure condition deciding process is carried out on the basis of the shooting distance estimated by the face area size. If, on the other hand, no blink is detected, the exposure condition deciding process is carried out on the basis of the shooting distance calculated by the AF detection circuit 53.

[First Example/Human Subject]

Where the subject is a person, as shown in FIG. 15A, the shooting distance estimated by the face area size is fundamentally equal or close to the shooting distance calculated based on the contrast value, as shown in FIGS. 15B and 15C. In that case, the shooting distance estimation circuit 62 judges that the difference between the estimated and calculated shooting distances is not over the predetermined threshold value, so the exposure condition deciding process, as set forth later, is carried out on the basis of the shooting distance estimated by the face area size.

[Second Example/Human Subject]

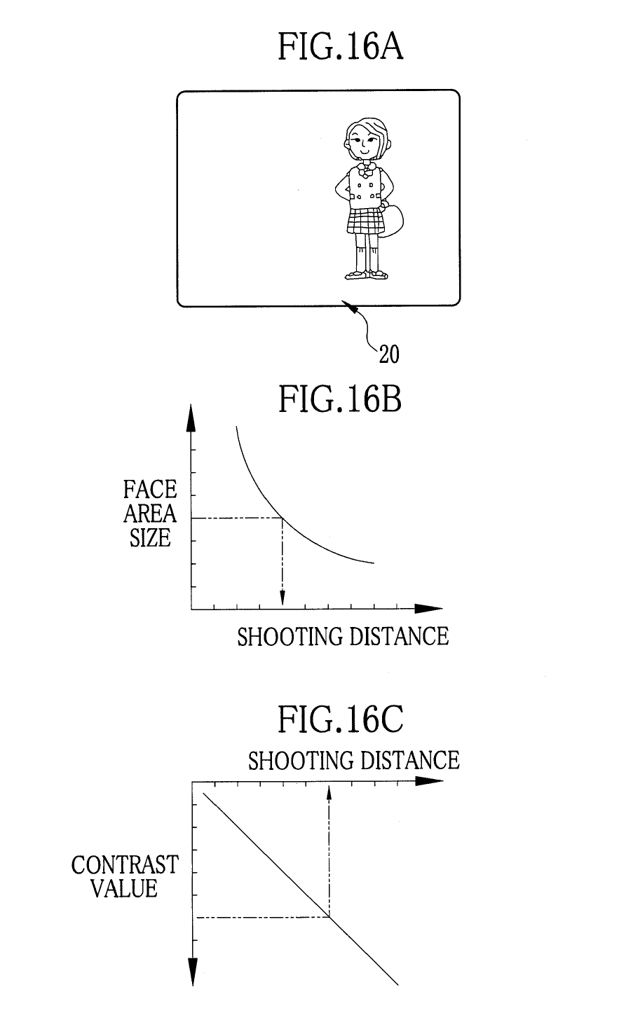

Even though the subject is a person, as shown in FIG. 16A, the shooting distance estimated by the face area size can differ from the shooting distance calculated based on the contrast value due to errors and equations, as shown in FIGS. 16B and 16C. If the difference between the estimated and calculated shooting distances is over the threshold value, the blink sensing circuit 63 carries out the blink sensing process. Then, blinks are detected from the subject, so the exposure condition deciding process is carried out on the basis of the shooting distance estimated by the face area size.

[Third Example/Nonhuman Subject]

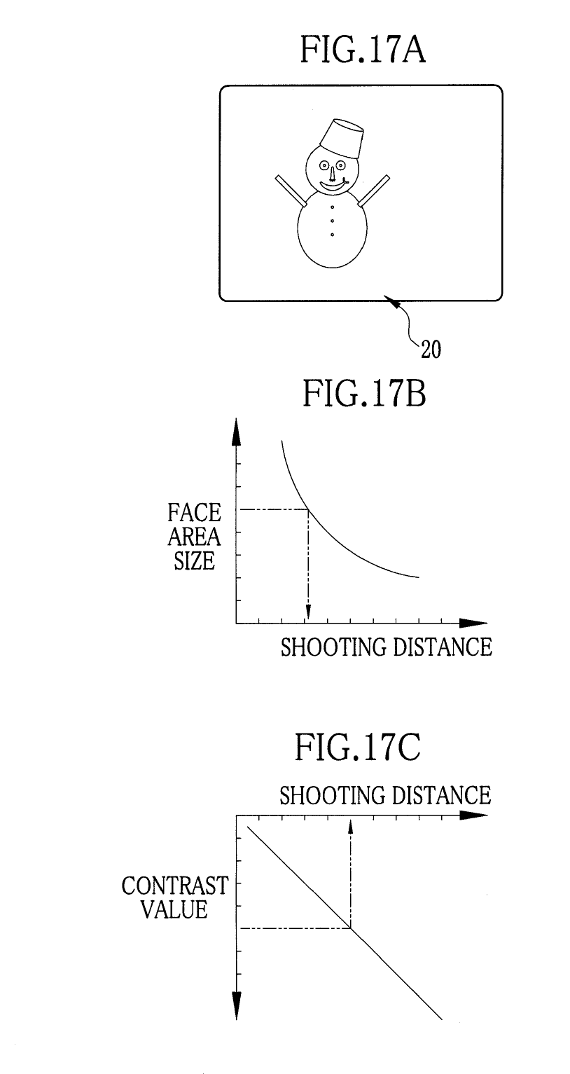

There may be a case where the face extraction circuit 60 extracts a face area from an image though the subject is not a person, but a statue, a doll or the like, as shown for example in FIG. 17A. In that case, the shooting distance estimated by the face area size can differ from the shooting distance calculated based on the contrast value, as shown in FIGS. 17B and 17C. If the difference between the estimated and calculated shooting distances is over the threshold value, the blink sensing circuit 63 carries out the blink sensing process. Because no blink is detected from the nonhuman subject, the exposure condition deciding process is carried out on the basis of the shooting distance calculated by the AF detection circuit 53.

[Error Warning]

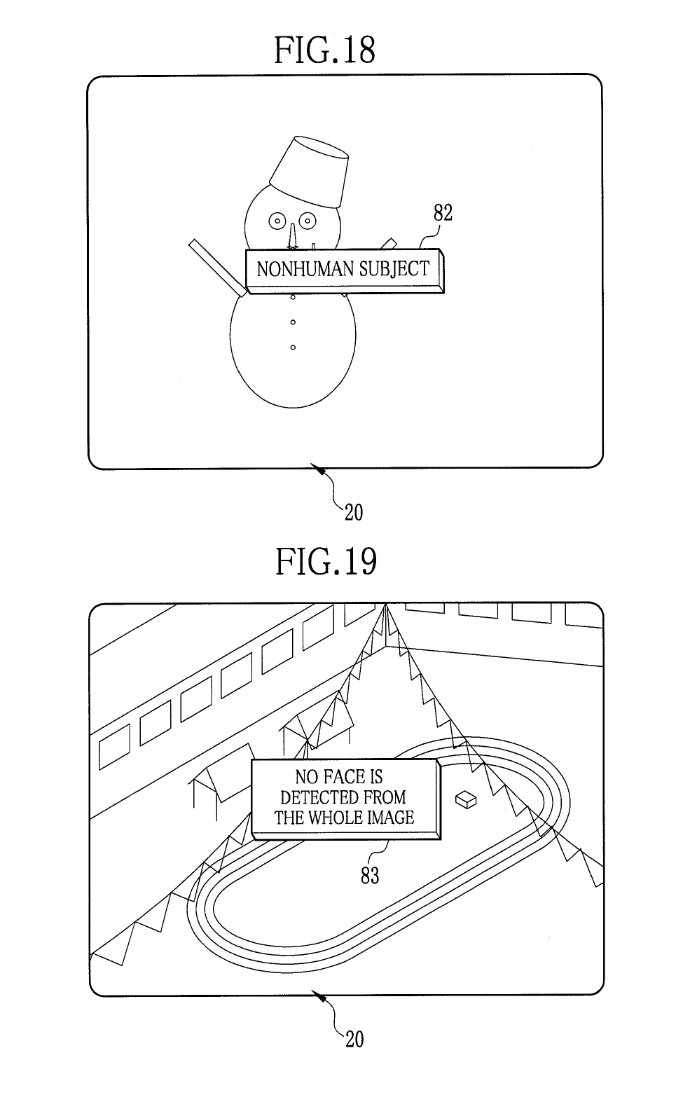

When the difference between the estimated and calculated shooting distances is over the threshold value and no blink is detected from the extracted face area, the CPU 31 causes the LCD panel 20 to display an error warning 82 informing that the face area extracted by the face extraction circuit 60 is not a person's, as shown for example in FIG. 18. Thus, the user can notice that the face area extracted by the face extraction circuit 60 is not a person's. In the same way, if the face extraction circuit 60 does not extract any face area from the whole image, the LCD panel 20 displays an error warning 83 that no face area is extracted from the whole image, as shown for example in FIG. 19. When the error warning 82 or 83 is displayed, the exposure condition deciding process is carried out on the basis of the shooting distance calculated by the AF detection circuit 53. It is possible to give an alarm from the speaker 43 in addition to displaying the error warning 82 or 83.

[Exposure Condition Deciding]

The exposure condition control circuit 64 carries out the exposure condition deciding process for deciding the aperture value of the stop 25, the light amount from the flash projector 13 and other exposure conditions, on the basis of the shooting distance calculated by the AF detection circuit 53 or estimated by the shooting distance estimation circuit 62. If the face extraction circuit 60 extracts more than one face area, the exposure condition control circuit 64 principally decides the exposure conditions for each individual face area, as set forth in detail later. If, however, two or more of the extracted face areas correspond to such subjects or persons that can be focused in a depth of field of the imaging lens 12, the exposure condition control circuit 64 sorts these face areas into a group, and decide the exposure conditions for the group. Note that the depth of field is a shooting distance range, within which objects are in focus of the imaging lens 12 at the same focal position, and that the CPU 31 calculates the depth of field from the position of the zoom lens 24 and the aperture value of the stop 25 on the basis of numerical data stored previously in the ROM 52.

[Face Area Grouping]

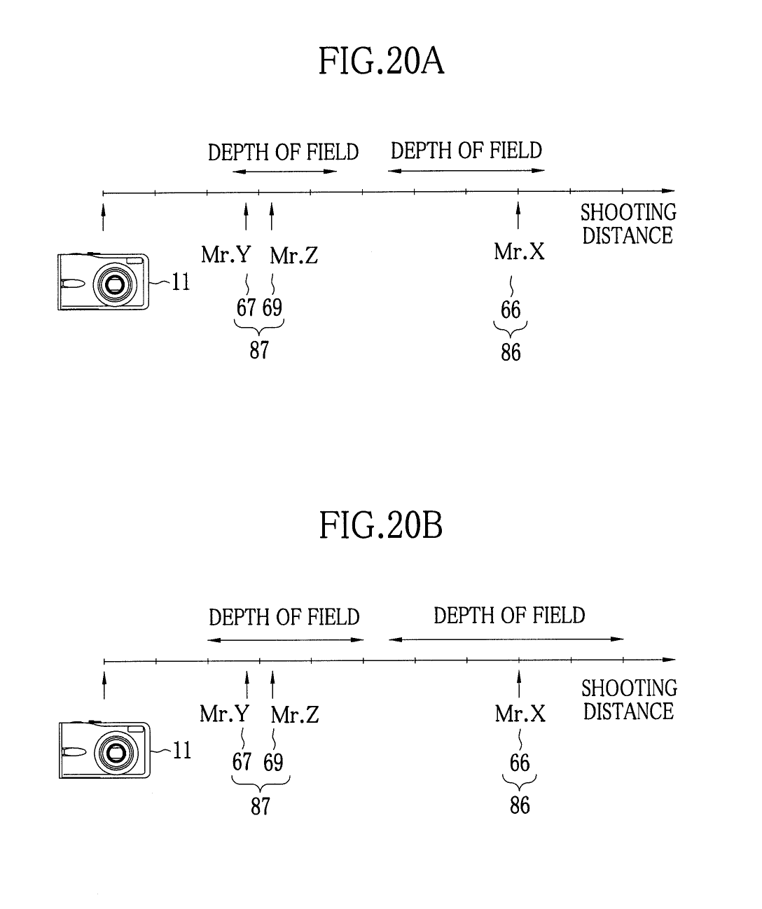

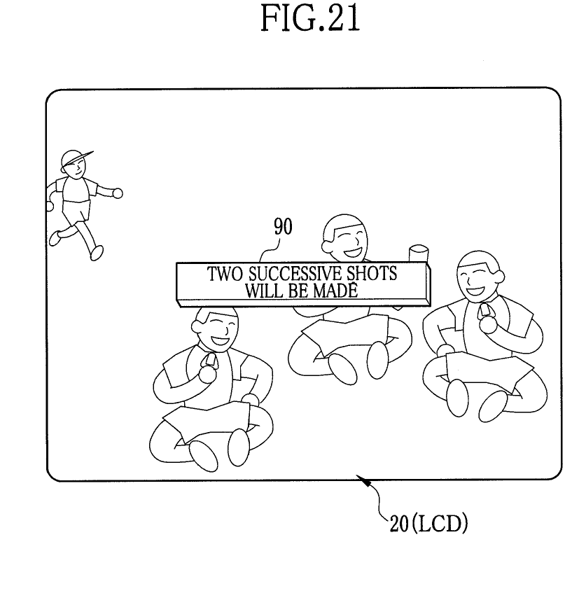

The exposure condition control circuit 64 compares shooting distances to the persons corresponding to the extracted face areas, to calculate differences between the respective shooting distances to the persons. The exposure condition control circuit 64 further judges whether the respective differences in shooting distance are within the depth of field. Take the image of FIG. 11A for example, where the face areas are extracted from the persons 66, 67 and 69, called Mr. X, Mr. Y and Mr. Z, a shooting distance to the person 67 differs a little from a shooting distance to the person 69, as shown in FIG. 20A, so the exposure condition control circuit 64 judges that Mr. Y and Mr. Z 67 and 69 can be focused in the same depth of field. On the contrary, a shooting distance to Mr. X 66 differs so much from the shooting distances to Messrs. Y and Z 67 and 69, that the exposure condition control circuit 64 judges that Mr. X 66 cannot be focused in the same depth of field as Messrs. Y and Z 67 and 69. As a result, Mr. X 66 is sorted in to a first group 86, whereas Messrs. Y and Z 67 and 69 are sorted into a second group 87.

[Face Area Regrouping]

When the face areas are sorted into a plurality of groups while the aperture value is not maximum, i.e. the aperture size of stop 25 is set to the minimum, the exposure condition control circuit 64 resets the initial grouping, and regroups the face areas after the stop 25 is narrowed to enlarge the depth of field, as shown in FIG. 20B. Even after enlarging the depth of field, Mr. X 66 cannot be focused in the same depth of field as Messrs. Y and Z 67 and 69 in the example shown in FIG. 20, so Mr. X 66 is sorted in to the first group 86, and Messrs. Y and Z 67 and 69 are sorted into the second group 87 again. In some cases, however, the number of face area groups can be reduced by this regrouping.

[Order of Deciding Exposure Conditions]

The exposure condition control circuit 64 decides the respective exposure conditions for the individual groups in turn, in the order from one group including the largest face area. Assuming that the face area of Mr. Y 67 is the largest and the face area of Mr. X is the smallest of the extracted face areas, the exposure conditions are decided first for the second group 87 as including the largest face area, and then the exposure conditions for the first group 86 are decided.

[Successive Portrait Mode/Order of Successive Shots]

When the exposure condition control circuit 64 decides different sets of exposure conditions as set forth above, the CPU 31 lets the digital camera 11 make successive shots upon the shutter release button 17 being pressed to the full, to get and record images under the different exposure conditions from each other. The respective sets of exposure conditions are used for the successive shots in the same order as these sets of exposure conditions are decided. In advance of the successive shots, the CPU 31 lets the LCD panel 20 display information 90 on how many successive shots the digital camera 11 is going to make, as shown for example in FIG. 21. During the successive shots, the LCD panel 20 successively displays the images taken by the successive shots, each immediately after it is taken.

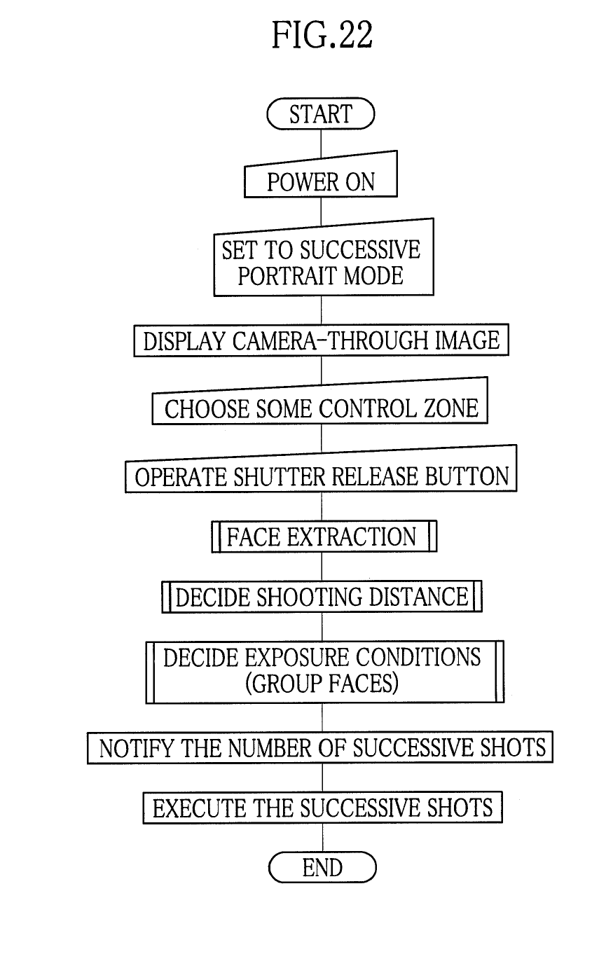

Now the operation of the digital camera 11 of the first embodiment as shown in FIGS. 1 to 3 will be described with reference to the flowcharts of FIGS. 22 to 27.

As shown in FIG. 22, the power button 16 is first pressed to turn the power on. Thereafter when the digital camera 11 is switched to the successive portrait mode by operating the functional mode dial 18, the LCD panel 20 displays the camera-through image on a screen divided into the control zones AA to DF as shown in FIG. 10. When the user touches some of the control zones AA to DF on the LCD panel 20, the touched control zones are provisionally chosen, and their background colors are darkened, as shown in FIG. 11A. If adjoining two or more zones are chosen, they are dealt with a united control zone. Thereafter when the shutter release button 17 is pressed, the choice is decided on the control zones.

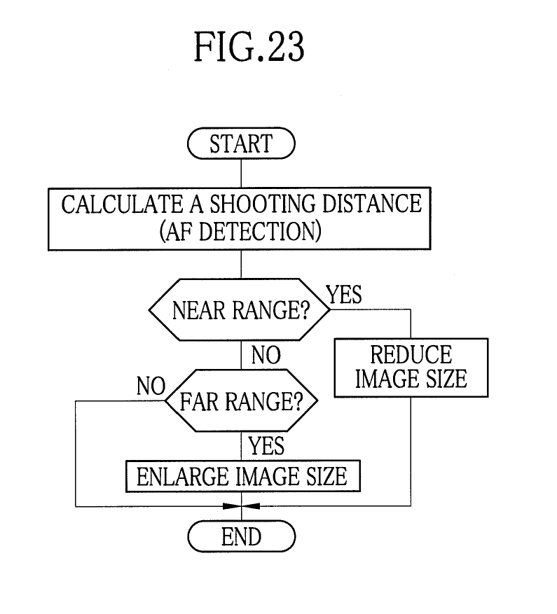

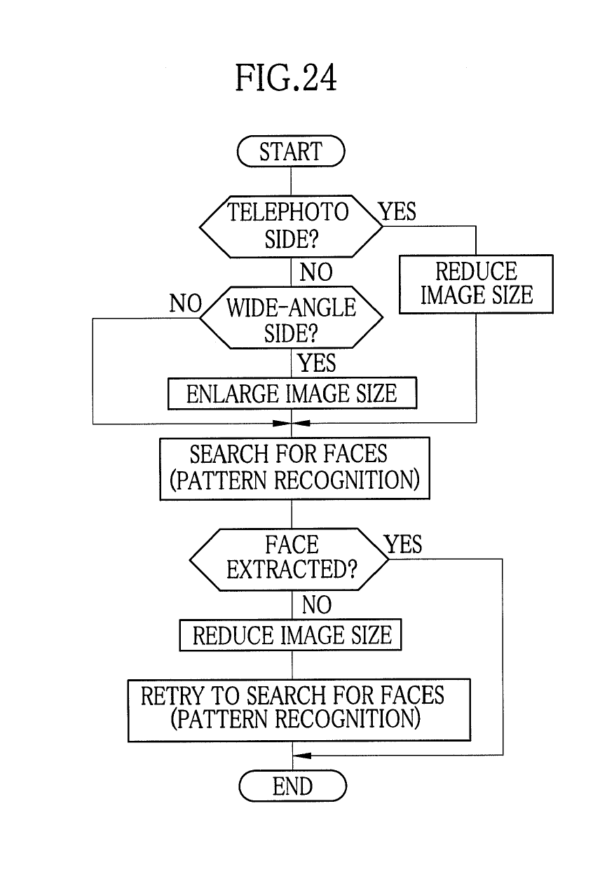

When the chosen control zones are determined as control zones, the face extraction process is carried out on one control zone after another. First, the AF detection circuit 53 calculates a shooting distance as shown in FIG. 23. If the calculated shooting distance is in the near range, the image size control circuit 61 reduces the image prior to the face extraction process as shown in FIGS. 6A and 6B. If the calculated shooting distance is in the far range, the image size control circuit 61 enlarges the image prior to the face extraction process as shown in FIGS. 7A and 7B. Furthermore, as shown in FIG. 24, if the zoom lens 24 is on the telephoto side, the image size control circuit 61 reduces the image prior to the face extraction process as shown in FIGS. 8A and 8B. If the zoom lens 24 is on the wide-angle side, the image size control circuit 61 enlarges the image prior to the face extraction process as shown in FIGS. 9A and 9B. Thereafter, the face extraction circuit 60 carries out the face extraction process according to the pattern recognition method using the face patterns 65. If no face area is detected from the chosen control zones, the image size control circuit 61 reduces the image, and thereafter the face extraction circuit 60 searches for any face areas again on the reduced image, as shown in FIGS. 5A and 5B.

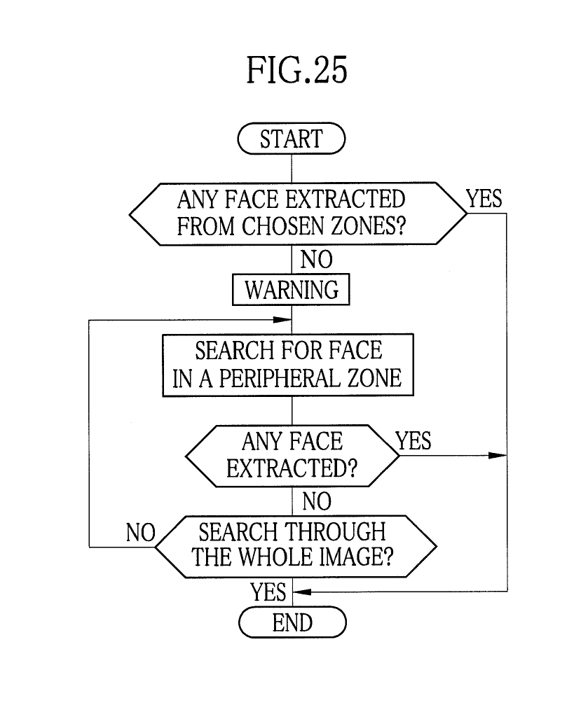

If no face area is detected from the chosen control zones even after the repeated searching, the error warning 77 is displayed on the LCD panel 20, as shown in FIGS. 12 and 25. In the self-timer shooting, the supplemental light projector 14 emits light for warning to the user that no face area is detected. Simultaneously, the face extraction circuit 60 carries out the face extraction process on the first peripheral zone 79 surrounding the initially chosen control zones. If no face area is detected from the first peripheral zone 79, the face extraction circuit 60 carries out the face extraction process on the second peripheral zone 80 surrounding the first peripheral zone 79, as shown in FIG. 13A.

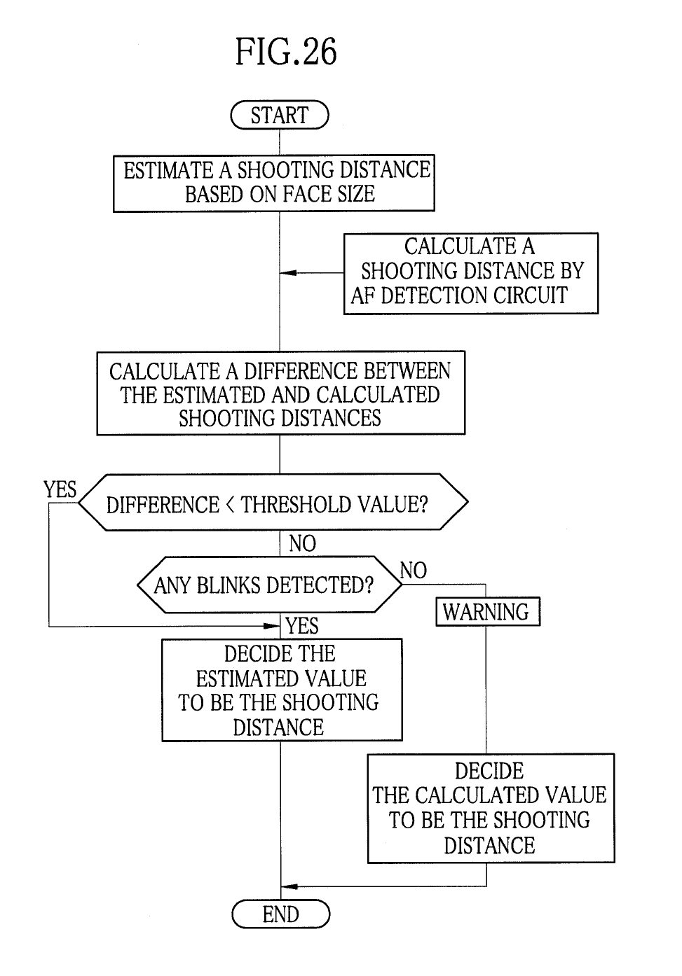

If a face area is detected by the face extraction circuit 60, the shooting distance estimation circuit 62 estimates a shooting distance to the subject by the detected face area size, as shown in FIG. 26. The shooting distance estimation circuit 62 compares the estimated shooting distance with the shooting distance calculated by the AF detection circuit 53, and calculates a difference between the estimated and calculated shooting distances. When the difference is not over the predetermined threshold value, like in the example shown in FIG. 15, the value estimated by the shooting distance estimation circuit 62 is decided to be the shooting distance. On the other hand, if the difference is over the threshold value, like in the example shown in FIG. 16, the blink sensing circuit 63 carries out the blink sensing process. If some blinks are detected from the extracted face area, the value estimated by the shooting distance estimation circuit 62 is decided to be the shooting distance. If no blink is detected from the extracted face area, the error warning 82 is displayed on the LCD panel 20, or the alarm is given from the speaker 43, to inform the user of the fact that the extracted face area is not a person's, as shown in FIG. 18. In that case, the value calculated by the AF detection circuit 53 is decided to be the shooting distance (see FIG. 17).

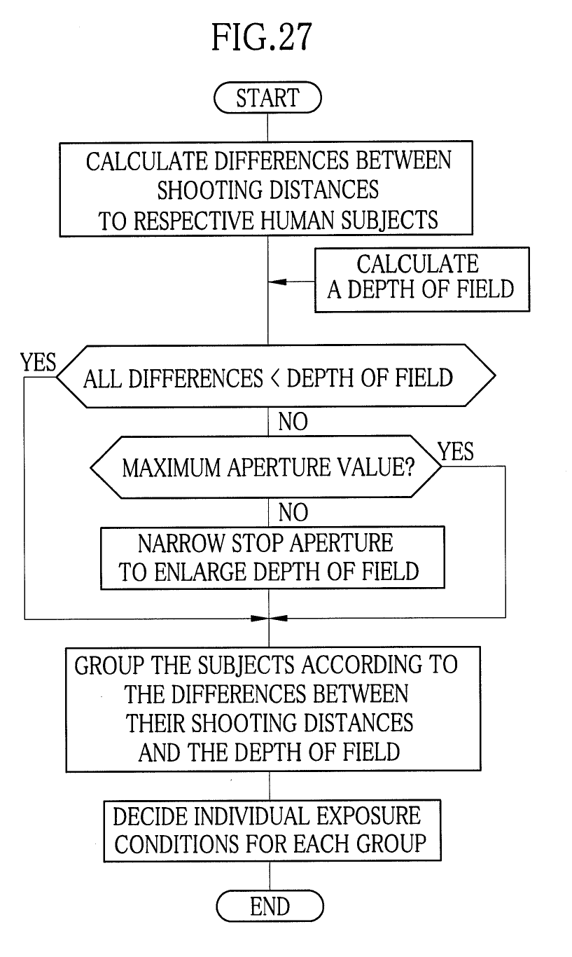

When a plurality of face areas are extracted, the exposure condition control circuit 64 compares shooting distances to the subjects or persons corresponding to the extracted face areas, to calculate differences between the respective shooting distances to the persons, as shown in FIG. 27. The exposure condition control circuit 64 further judges whether the differences in shooting distance are within a depth of field that is calculated by the CPU 31 (see FIG. 20A). If the calculated differences between the shooting distances to the subjects are not within the depth of field while the aperture value is not the maximum, that is, the aperture size of stop 25 is not the minimum, the stop 25 is narrowed to enlarge the depth of field, and thereafter the exposure condition control circuit 64 judges again whether the differences in shooting distance are within the enlarged depth of field, as shown in FIG. 20B. According to the results of judgments, the exposure condition control circuit 64 sorts those subjects who can be focused in the same depth of field into the same group, to decide the exposure conditions for each group individually.

Then the LCD panel 20 displays the information 90 on the number of successive shots that are going to be made, as shown in FIG. 21. Upon the shutter release button 17 being pressed to the full, the successive shots are executed, while the LCD panel 20 displays the just-obtained images successively.

[Digital Camera with Interchangeable Lens Unit]

Although the first embodiment of the present invention has been described with respect to the digital camera 11 that has the imaging lens 12 integrated therein, the present invention is not limited to the first embodiment, but is applicable to a digital camera, of which a lens unit having an imaging lens 12 integrated therein is detachably attachable to a main body of the camera.

### Second Embodiment

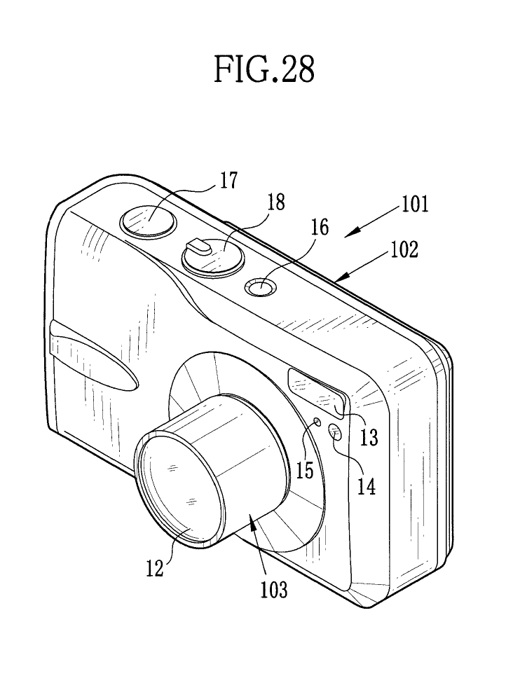

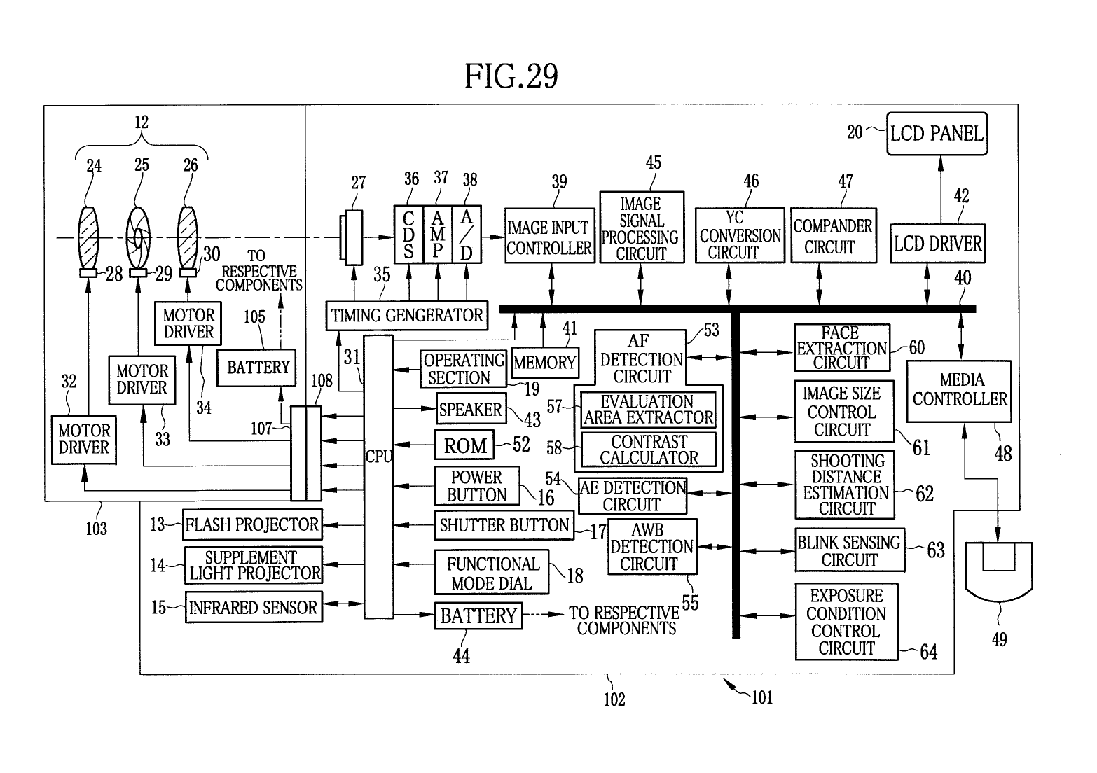

Now a lens-interchangeable digital camera 101 according to a second embodiment will be described with reference to FIGS. 28 and 29, wherein like parts are designated by the same reference numerals as in the first embodiment, so details of these parts may be omitted in the following description.

As shown in FIG. 28, the digital camera 101 is of a lens-interchangeable type, wherein a lens unit 103 is detachably attachable to a main body 102. The lens unit 103 holds an imaging lens 12 in a lens barrel and a not-shown mounting mechanism is provided on a rear end of the lens barrel. The main body 102 is provided on its front with a not-shown mounting mechanism, so the mounting mechanism of the lens unit 103 is engaged with the mounting mechanism of the main body 102, for example, by inserting the mounting mechanism of the lens unit 103 in the mounting mechanism of the main body 102 in a parallel direction to an optical axis of the imaging lens 12, and then turning the lens unit 103 about the optical axis in a predetermined direction through a predetermined angle. These mounting mechanisms may be of a screw mount type or a bayonet mount type using several claws.

The main body 102 has a power button 16, a shutter release button 17 and a functional mode dial 18 on its top side. The main body 102 also has an LCD panel 20 and an operating section 19 on its back side (see FIG. 29).

As shown in FIG. 29, the lens unit 103 is provided with motors 28 to 30, motor drivers 32 to 34 and a battery 105 besides the imaging lens 12. The battery 105 supplies power to the respective components of the lens unit 103 when the power button 16 is turned on. As the battery 105 for driving the imaging lens 12 is provided in the lens unit 103 separately from a battery 102 mounted in the main body 102, the digital camera 101 can smoothly make successive shots in the successive portrait mode.

The mounting mechanism of the lens unit 103 is provided with a contact section 107. The contact section 107 consists of a number of contacts for exchanging electric signals between the lens unit 103 and the main body 102, e.g. for sending control signals from the main body 102 to the lens unit 103, for controlling the motor drivers 32 to 34 and the lens battery 105. Also the mounting mechanism of the main body 102 is provided with a contact section 108 that consists of the same number of contacts as the contact section 107 of the lens unit 103. Thus, the contact section 107 is electrically connected to the contact section 108 of the main body 102, as the mounting mechanism of the lens unit 103 is engaged with that of the main body 102.

The digital camera 101 of the second embodiment operates substantially equivalently to the digital camera 11, so the operation of the second embodiment will be omitted.

[Variation of Face Extraction Process]

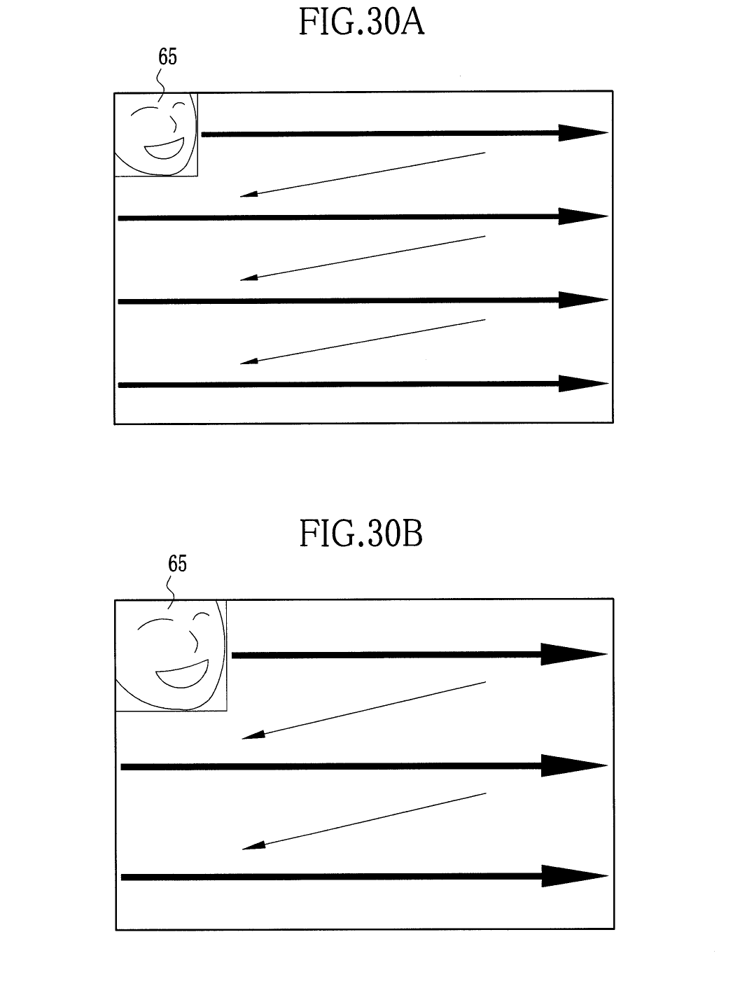

Although the face extraction process is carried out using the face patterns 65 of a fixed size in the above described embodiment, it is possible to change the size of the face patterns 65. In that case, a face extraction circuit 60 slides the face patterns 65 on the image of a fixed size, to discriminate an area having a similar pattern to the face pattern 65, and extract it as a face area, as shown in FIG. 30A. Thereafter, as shown in FIG. 30B, the faceextraction circuit 60 enlarges the facepatterns 65, and slides the enlarged face patterns 65 on the same image, to extract a larger face area. In this embodiment, the image size is kept unchanged during the face extraction process, so an image size control circuit 61 does not work for the face extraction process.

[Subject/Near]

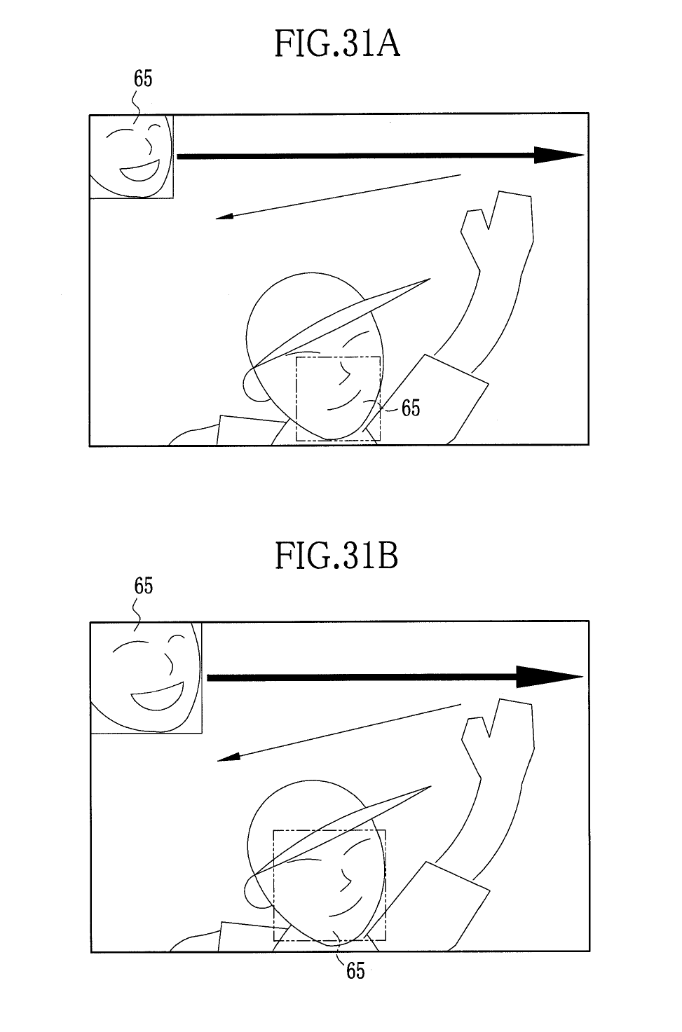

The size of a face area in the image varies depending upon the shooting distance to the subject. If the subject exists in a near range that is shorter than a predetermined distance, the face area is larger than the square face patterns 65 of 32×32 pixels, as shown for example in FIG. 31A, so it is hard to detect the face area with the face patterns 65 of the initial size. Therefore, if the shooting distance calculated by an AF detection circuit 53 is shorter than the predetermined distance, the face extraction circuit 60 first enlarges the size of the face patterns 65, as shown in FIG. 31B, and then slides the enlarged face patterns 65 on the image to extract the face area.

[Subject/Far]

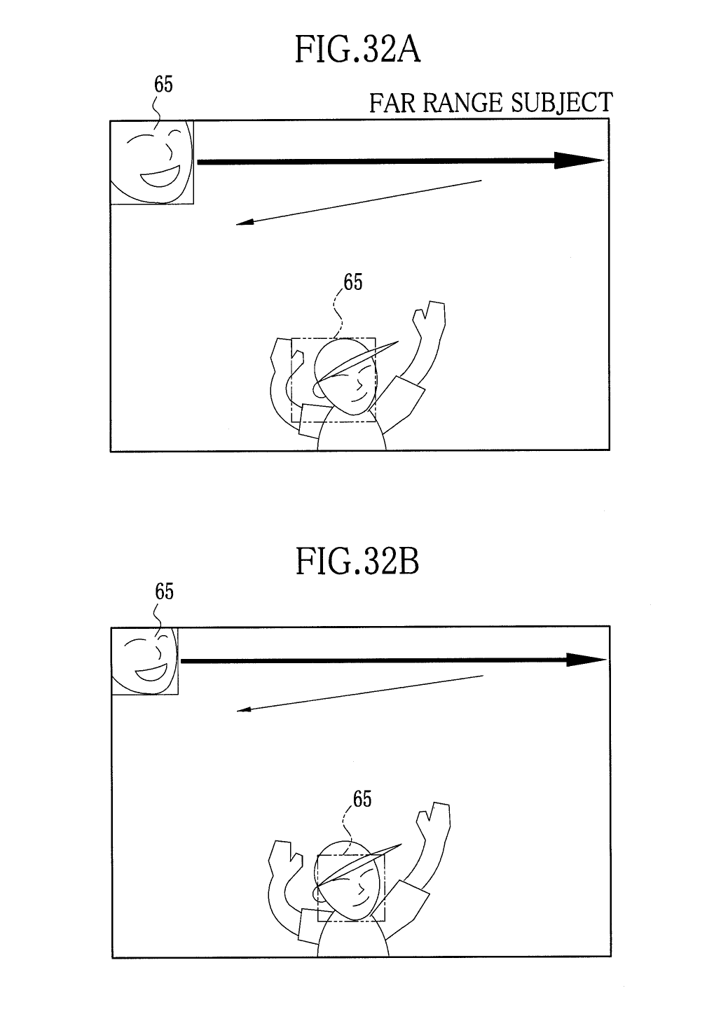

If the subject exists in a far range that is beyond the predetermined distance, the face area is smaller than the square face patterns 65 of 32×32 pixels, as shown for example in FIG. 32A, so it is hard to detect the face area with the face patterns 65 of the initial size. Therefore, if the shooting distance calculated by the AF detection circuit 53 is longer than the predetermined distance, the face extraction circuit 60 first reduces the size of the face patterns 65, as shown in FIG. 32B, and then slides the face patterns 65 on the enlarged image to extract the face area.

[Zoom/Tele]

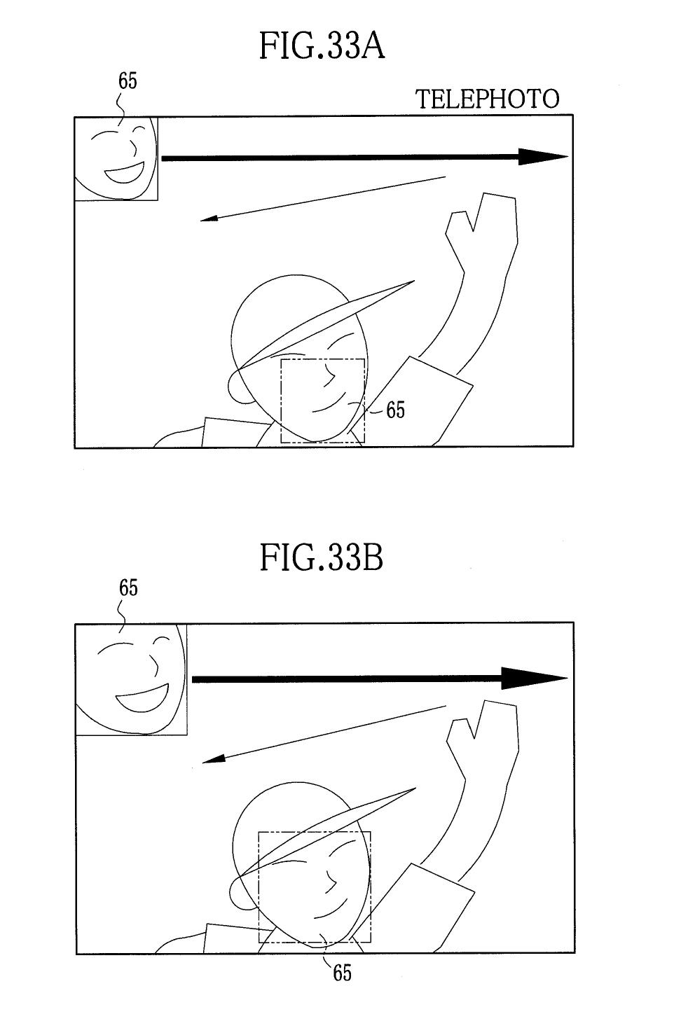

The size of a face area in the image also varies depending upon the focal length. That is, if the zoom lens 24 is on a telephoto side from a predetermined position, the face area is larger than the square face patterns 65 of 32×32 pixels, as shown for example in FIG. 33A, so it is hard to detect the face area with the face patterns 65 of the initial size. Therefore, if the CPU 31 judges that the zoom lens 24 is on the telephoto side, the face extraction circuit 60 first enlarges the size of the face patterns 65, as shown in FIG. 33B, and then slides the enlarged face patterns 65 on the image, to extract the face area.

[Zoom/Wide]

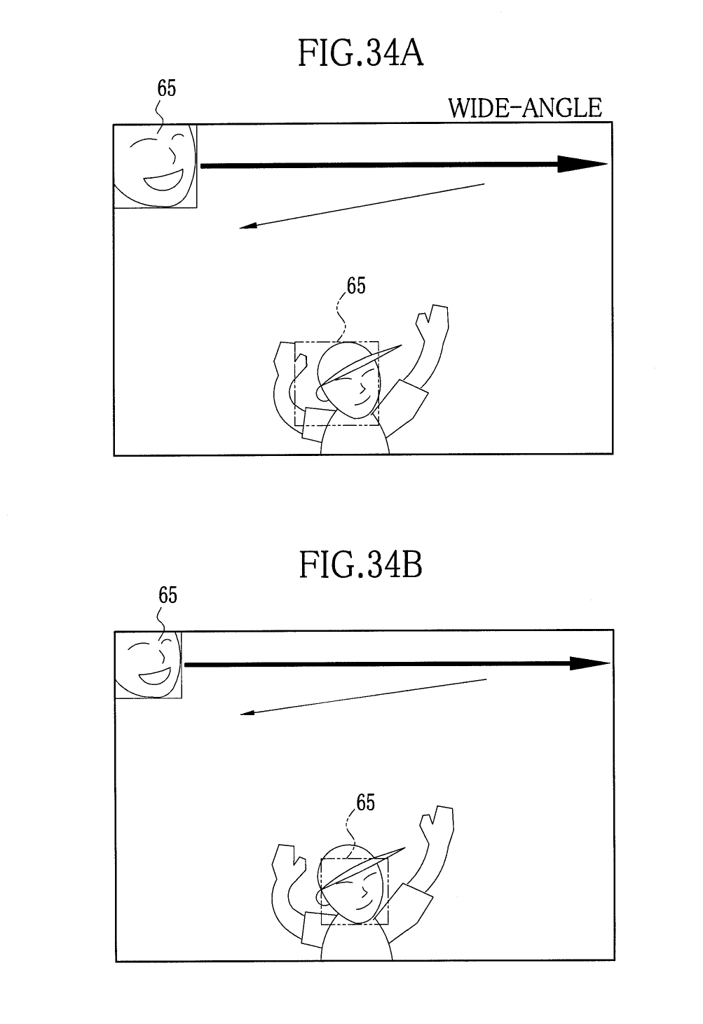

If the zoom lens 24 is on a wide-angle side from the predetermined position, the face area size is smaller than the square face patterns 65 of 32×32 pixels, as shown for example in FIG. 34A, so it is hard to detect the face area with the face patterns 65 of the initial size. Therefore, if the CPU 31 judges that the zoom lens 24 is on the wide-angle side, the face extraction circuit 60 first reduces the size of the face patterns 65, as shown in FIG. 34B, and then slides the face patterns 65 on the image to extract the face area.

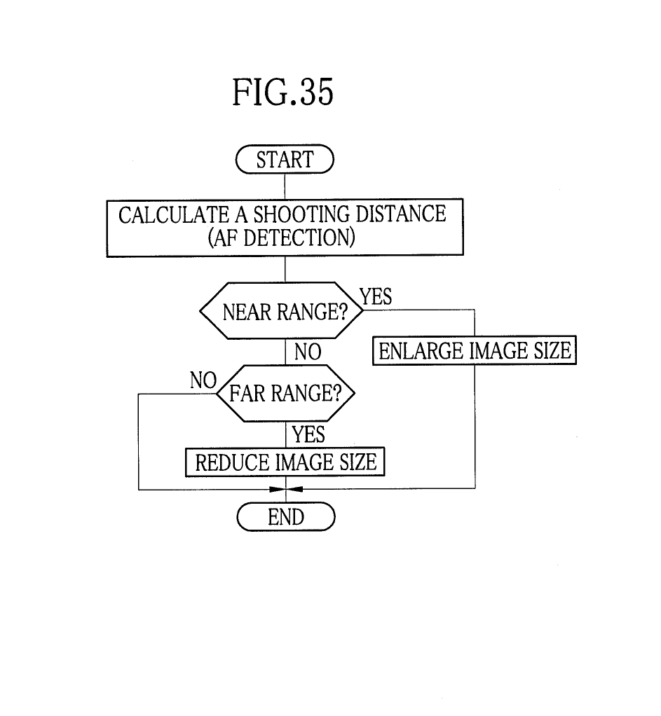

Namely, as shown in FIG. 35, if the shooting distance calculated by the AF detection circuit 53 is in the near range, the face extraction circuit 60 enlarges the size of the face patterns 65, as shown in FIGS. 31A and 31B. If the calculated shooting distance is in the far range, the face extraction circuit 60 reduces the size of the face patterns 65, as shown in FIGS. 32A and 32B.

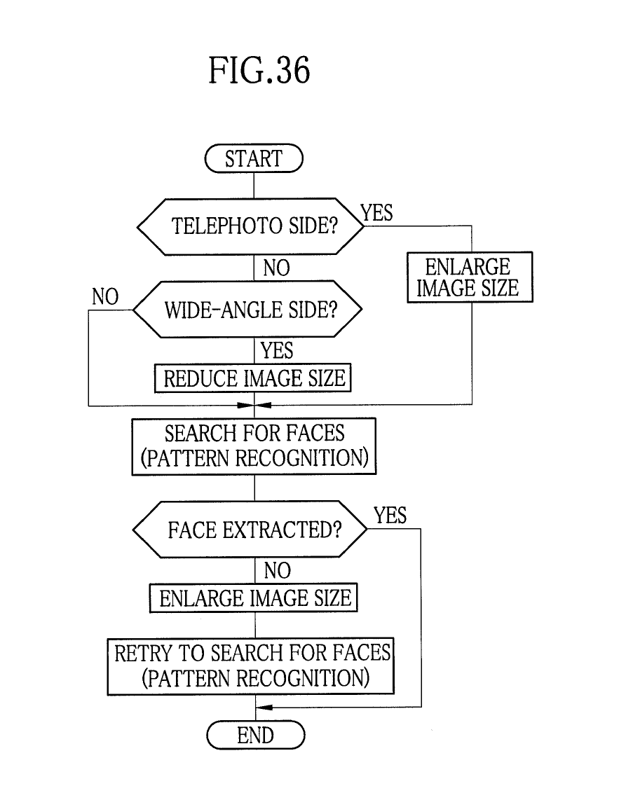

Furthermore, as shown in FIG. 36, if the zoom lens 24 is on the telephoto side, the face extraction circuit 60 enlarges the size of the face patterns 65, as shown in FIGS. 33A and 33B. If the zoom lens 24 is on the wide-angle side, the face extraction circuit 60 reduces the size of the face patterns 65, as shown in FIGS. 34A and 34B. Thereafter, the face extraction circuit 60 carries out the face extraction process according to the pattern recognition method using the face patterns 65. If no face area is extracted, the face extraction circuit 60 enlarges the size of the face patterns 65, and retries to detect a face area using the enlarged face patterns 65, as shown in FIGS. 30A and 30B.

[Choice of Control Zones]

In the above embodiment, the LCD panel 20 doubles as the touch panel that functions as a device for choosing one or more of the control zones AA to DF of the camera-through image, and the user touches the control zones directly on the LCD panel 20 to choose them provisionally. However, the device for choosing the control zones is not limited to this embodiment, but may be an arrow key button 22 or the like that is operated to choose the control zones provisionally by pointing them with a cursor on the LCD panel 20.

Although the provisionally chosen control zones are discriminated from others by darkening their background colors in the above embodiment, as shown in FIG. 11A, they may be discriminated in another fashion. For example, as shown in FIG. 11B, the provisionally chosen control zones may be bounded with a frame in the unit of control zone 70, 71 or 72.

[Adjoining Zones]

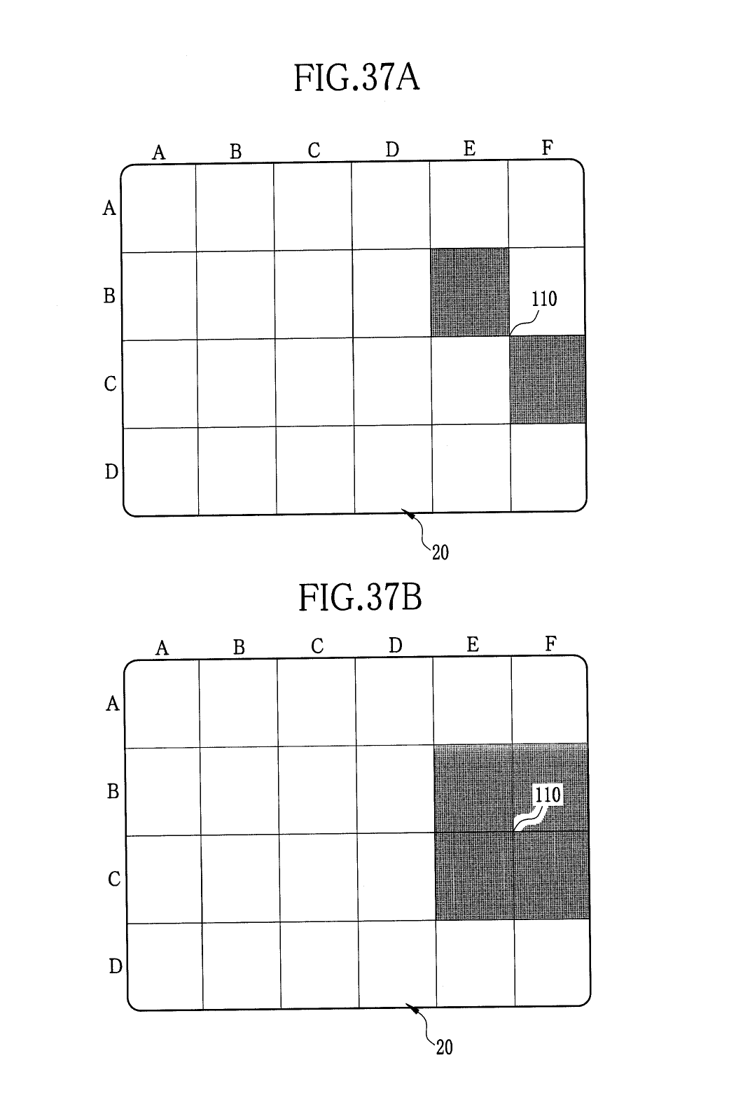

In the above embodiment, if adjoining two or more zones are chosen, they are dealt with a united control zone. However, the present invention is not limited to this embodiment. According to a variation shown in FIG. 37A, if the user chooses a couple of control zones BE and CF that share a vertex 110, other control zones BF and CE that share the same vertex 110 are considered to be chosen, and all of these control zones BE, BF, CE and CF are treated as a united control zone.

[Order of Processing]

In the above embodiment, the chosen control zones are subjected to the face extraction process and other processes in turn, in the order determined by the sequence of time when they are chosen by the user. However, the order of processing is not limited to this embodiment. For example, it is possible to process the control zones in the order from the nearest to the center of the image. According to this modification, in the example shown in FIG. 11A, the second control zone 71 including the nearest control zone CC to the image center is processed first, and the third control zone 72 including the control zones BE and CE is processed next. The first control zone 70 consisting of the most peripheral control zone AA is processed last.

As another modification, it is possible to decide the order of processing by the size of the control zones. In the example shown in FIG. 11A, the third control zone 72 is the largest as it consists of four control zones BE, BF, CE and CF, so the third control zone 72 is processed first. Next the second control zone 71 consisting of two control zones CB and CC is processed, and the third control zone 70 consisting of a single control zone AA is processed last.

[Re-Extraction]

If no face area is extracted from the chosen control zones, the face extraction process is repeated while extending the searching control zone gradually from the chosen one to the peripheral ones in the above embodiment. However, as shown in FIG. 13B, it is possible to retry the face extraction process at once on all of those control zones 81 which are not chosen by the user.

[Order of Deciding Exposure Conditions]

In the above embodiment, if more than one face area is detected, exposure conditions are decided for the respective face areas in the order from the largest face area. However, it is possible to decide exposure conditions for the face areas in the order from the nearest to the image center.

[Order of Successive Shots]

In the above embodiment, the successive shots are executed under the different sets of exposure conditions in the same order as these sets of exposure conditions are decided. But the present invention is not limited to this embodiment. For example, it is possible to decide the order of successive shots according to the shooting distances to the respective groups of the subjects that correspond to the extracted face areas. Preferably, the imaging lens is focused at a different group of the subjects from one shot to another during the successive shots, in the order from the shot at the shortest shooting distance to the shot at the longer shooting distance, or from the shot at the longest shooting distance to the shot at the shorter shooting distance. Thereby, a series of images focused at the different groups of the human subjects are taken and recorded successively upon one operation on the shutter release button, while driving the imaging lens in one direction only. This configuration improves the efficiency of driving the imaging lens and thus saves the time taken for a set of successive shots.

As described so far, the present invention is not to be limited to the above embodiments but, on the contrary, various modifications will be possible without departing from the scope of claims appended hereto.

What is claimed is:

1. An imaging apparatus comprising:
an imaging device for obtaining an electronic image from an optical image of a subject formed through an imaging lens;
a display device for displaying the obtained image on a screen divided into control zones;
a choosing device operated to choose some of said control zones; and
a processing device for processing data of the obtained image, wherein said processing device processes the data in each of the chosen control zones individually, but treats adjoining two or more of the chosen control zones as a united control zone.

2. An imaging apparatus as recited in claim 1, wherein said processing device carries out a face extraction process for extracting face areas from the image.

3. An imaging apparatus as recited in claim 2, wherein if more than one control zone is chosen, said face extraction process is carried out in turn from one control zone to another.

4. An imaging apparatus as recited in claim 3, wherein said face extraction process is carried out in the order from the first chosen control zone to the last chosen one.

5. An imaging apparatus as recited in claim 3, wherein said face extraction process is carried out in the order from the nearest one of the chosen control zones to a center area of the image.

6. An imaging apparatus as recited in claim 3, wherein said face extraction process is carried out in the order from the largest one of the chosen control zones.

7. An imaging apparatus as recited in claim 2, further comprising a warning device that gives a warning when no face area is extracted from the chosen control zones.

8. An imaging apparatus as recited in claim 7, wherein said display device constitutes said warning device.

9. An imaging apparatus as recited in claim 7, wherein said warning device comprises a device for emitting a warning light toward the subject.

10. An imaging apparatus as recited in claim 2, wherein said processing device carries out said face extraction process on other control zones than the chosen control zones if no face area is extracted from the chosen control zones.

11. An imaging apparatus as recited in claim 2, further comprising:
an operating device operated to record the image as obtained through said imaging device;
an exposure condition controlling device for deciding a set of exposure conditions of said imaging device on the basis of a face area extracted through said face extraction process; and
a successive shot control device that controls said exposure condition controlling device to decide different sets of exposure conditions on the basis of respective face areas if more than one face area is extracted, and controls said imaging device to make successive shots to take and record a number of images under the different sets of exposure conditions upon one operation on said operating device.

12. An imaging apparatus as recited in claim 11, further comprising:
a device for detecting shooting distances to respective subjects corresponding to the extracted face areas;
a calculation device for calculating differences between the shooting distances to the subjects; and
a judging device for judging whether the calculated differences are within a particular range, wherein said exposure condition control device sorts such face areas into a group that correspond to those subjects, between which the difference in shooting distance is within the particular range, and decides a set of exposure conditions for each group.

13. An imaging apparatus as recited in claim 12, wherein said particular range is a depth of field of said imaging lens.

14. An imaging apparatus as recited in claim 13, wherein if the extracted face areas are sorted into two or more groups, said exposure condition control device elongates the depth of field by narrowing a stop aperture of said imaging lens and sorts the face areas again with reference to the elongated depth of field, to decide a set of exposure conditions for each group as sorted with reference to the elongated depth of field.

15. An imaging apparatus as recited in claim 12, wherein if the extracted face areas are sorted into two or more groups, said exposure condition control device decides the exposure conditions for one group to another in a predetermined order, and said imaging device makes the successive shots under the respective sets of exposure conditions in the same order as these sets of exposure conditions are decided.

16. An imaging apparatus as recited in claim 15, wherein the exposure conditions are decided in the order from a group including the nearest face area to the center of the image.

17. An imaging apparatus as recited in claim 15, wherein the exposure conditions are decided in the order from a group including the largest face area among of the extracted ones.

18. An imaging apparatus as recited in claim 12, wherein the successive shots are made while focusing said imaging lens at a different group of the subjects from one shot to another, in the order from a group of the shortest shooting distance or from a group of the longest shooting distance.

19. An imaging apparatus as recited in claim 2, wherein said processing device slides face patterns of a constant size on the image, searching for face areas in said face extraction process, and said imaging apparatus further comprises an image size control device for changing the size of the image so as to adjust the sizes of face areas to the size of said face patterns.

20. An imaging apparatus as recited in claim 19, further comprising a distance detecting device for detecting a shooting distance to the subject, wherein said image size control device reduces the size of the image when the shooting distance is shorter than a predetermined distance, and enlarges the size of the image when the shooting distance is longer than the predetermined distance.

21. An imaging apparatus as recited in claim 19, wherein said imaging lens comprises a zoom lens, and said image size control device reduces the size of the image when said zoom lens is on a telephoto side, and enlarges the size of the image when said zoom lens is on a wide-angle side.

22. An imaging apparatus as recited in claim 19, wherein said image size control device reduces the size of the image when no face area is extracted from the image in an initial size, and said processing device slides said face patterns on the reduced image to retry to extract face areas.

23. An imaging apparatus as recited in claim 2, wherein said processing device slides face patterns of a variable size on the image to search for face areas in said face extraction process.

24. An imaging apparatus as recited in claim 23, further comprising a distance detecting device for detecting a shooting distance to the subject, wherein said processing device enlarges the size of said face patterns when the shooting distance is shorter than a predetermined distance, and reduces the size of said face patterns when the shooting distance is longer than the predetermined distance.

25. An imaging apparatus as recited in claim 23, wherein said imaging lens comprises a zoom lens, and said processing device enlarges the size of said face patterns when said zoom lens is on a telephoto side, and reduces the size of said face patterns when said zoom lens is on a wide-angle side.

26. An imaging apparatus as recited in claim 23, wherein said processing device enlarges the size of said face patterns when no face area is extracted, and retries to extract face areas using said enlarged face patterns.

27. An imaging apparatus as recited in claim 2, further comprising:
a shooting distance estimation device for estimating a shooting distance to a subject on the basis of the size of a face area of the subject extracted through said face extraction process;
a shooting distance measuring device for measuring a shooting distance to the subject;
a calculation device for calculating a difference between the estimated shooting distance and the measured shooting distance;
a second judging device for judging whether the calculated difference is over a predetermined threshold value; and
an exposure condition controlling device for deciding exposure conditions of said imaging device, wherein said exposure condition control device decides the exposure conditions on the basis of the estimated shooting distance when the calculated difference is not over the threshold value.

28. An imaging apparatus as recited in claim 27, further comprising a blink sensing device for sensing blinks from the face area when the calculated difference is over the threshold value, wherein said exposure condition control device decides the exposure conditions on the basis of the estimated shooting distance when said blink sensing device detects some blinks.

29. An imaging apparatus as recited in claim 28, wherein if said blink detecting device does not detect any blinks, said exposure condition control device decides the exposure conditions on the basis of the measured shooting distance.

30. An imaging apparatus as recited in claim 28, further comprising a warning device for giving a warning if said blink sensing device does not detect any blinks.

31. An imaging apparatus as recited in claim 30, wherein said warning device displays the warning on said display device.

32. An imaging apparatus as recited in claim 11, further comprising an information device for informing how many shots said imaging device is going to make upon one operation on said operating device.

33. An imaging apparatus as recited in claim 32, wherein said information device comprises said display device.

34. An imaging apparatus as recited in claim 27, wherein said shooting distance measuring device calculates the shooting distance on the basis of a contrast value of the image.

35. An imaging apparatus as recited in claim 11, wherein said display device seriatim displays the images taken by the successive shots, each immediately after it is taken.

36. An imaging apparatus as recited in claim 11, wherein said imaging lens, a driving device for driving said imaging lens and a battery for supplying power to said driving device are mounted in a lens unit that is detachably attachable to a main body, in which said imaging device and a battery for supplying power to said imaging device are mounted.

37. An imaging method using an imaging apparatus comprising an imaging device for obtaining an electronic image from an optical image of a subject formed through an imaging lens and a display device for displaying the obtained image, said imaging method comprising steps of:
displaying the obtained image in a condition divided into control zones;
choosing some of said control zones by use of an externally operable device; and
processing data of the image in each of the chosen control zones individually, while treating adjoining two or more of the chosen control zones as a united control zone.

38. An imaging method as recited in claim 37, wherein said processing step comprises a face extraction process for extracting face areas from the image.

39. An imaging method as recited in claim 38, wherein if more than one control zone is chosen, said face extraction process is carried out in turn from one control zone to another.

40. An imaging method as recited in claim 39, wherein said face extraction process is carried out in the order from the first chosen control zone to the last chosen one.

41. An imaging method as recited in claim 39, wherein said face extraction process is carried out in the order from the nearest one of the chosen control zones to a center area of the image.

42. An imaging method as recited in claim 39, wherein said face extraction process is carried out in the order from the largest one of the chosen control zones.

43. An imaging method as recited in claim 38, further comprising a warning step for warning when no face area is extracted from the chosen control zones.

44. An imaging method as recited in claim 43, wherein said warning step comprises a step of displaying a warning on said display device.

45. An imaging method as recited in claim 43, wherein said warning step comprises a step of emitting a warning light toward the subject.

46. An imaging method as recited in claim 38, wherein said face extraction process is carried out on other control zones than the chosen control zones if no face area is extracted from the chosen control zones.

47. An imaging method as recited in claim 38, further comprising steps of:
deciding different sets of exposure conditions on the basis of respective face areas if more than one face area is extracted; and
making successive shots through said imaging device, to take and record a number of images successively under the different sets of exposure conditions upon one operation on an operating device.

48. An imaging method as recited in claim 47, further comprising steps of:
detecting shooting distances to respective subjects corresponding to the extracted face areas;
calculating differences between the shooting distances to the subjects;
judging whether the calculated differences are within a particular range; and
sorting those face areas into a group which correspond to the subjects, between which the difference in shooting distance is within the particular range; and
deciding a set of exposure conditions for each group.

49. An imaging method as recited in claim 48, wherein said particular range is a depth of field of said imaging lens.

50. An imaging method as recited in claim 49, further comprising steps of:
elongating the depth of field by narrowing a stop aperture of said imaging lens if the extracted face areas are sorted into two or more groups; and
sorting the face areas again with reference to the elongated depth of field.

51. An imaging method as recited in claim 48, wherein if the extracted face areas are sorted into two or more groups, the exposure conditions are decided for one group to another in a predetermined order, and the successive shots are carried out under the respective sets of exposure conditions in the same order as these sets of exposure conditions are decided.

52. An imaging method as recited in claim 51, wherein the exposure conditions are decided in the order from a group including the nearest face area to the center of the image.

53. An imaging method as recited in claim 51, wherein the exposure conditions are decided in the order from a group including the largest face area among of the extracted ones.

54. An imaging method as recited in claim 48, wherein the successive shots are made while focusing said imaging lens at a different group of the subjects from one shot to another, in the order from a group of the shortest shooting distance or from a group of the longest shooting distance.

55. An imaging method as recited in claim 38, further comprising steps of:
estimating a shooting distance to a subject on the basis of the size of a face area of the subject extracted through said face extraction process;
measuring a shooting distance to the subject;
calculating a difference between the estimated shooting distance and the measured shooting distance;
judging whether the calculated difference is over a predetermined threshold value; and
deciding exposure conditions of said imaging device on the basis of the estimated shooting distance when the calculated difference is not over the threshold value.

56. An imaging method as recited in claim 55, further comprising a step of sensing blinks from the face area when the calculated difference is over the threshold value, wherein the exposure conditions are decided on the basis of the estimated shooting distance when some blinks are detected.

57. An imaging method as recited in claim 56, wherein if any blinks are not detected, the exposure conditions are decided on the basis of the measured shooting distance.

58. An imaging method as recited in claim 56, further comprising a step of warning if any blinks are not detected.

59. An imaging method as recited in claim 58, wherein said warning step comprises a step of displaying the warning on said display device.

60. An imaging method as recited in claim 47, further comprising a step of informing how many shots said imaging device is going to make upon one operation on said operating device.

61. An imaging method as recited in claim 60, wherein said informing step comprises a step of display the number of shots on said display device.

62. An imaging method as recited in claim 47, further comprising a step of displaying the images taken by the successive shots seriatim on said display device, each immediately after it is taken.
